(19) United States
(12) Patent Application Publication
(10) Pub. No.: US 2023/0004374 A1
(43) Pub. Date: Jan. 5, 2023

(54) COMPUTER SYSTEM AND CONTROL METHOD FOR FIRMWARE VERSION MANAGEMENT

(71) Applicant: FUJITSU LIMITED, Kawasaki-shi (JP)

(72) Inventors: Takashi IMAZATO, Kawasaki (JP); Masanori TAKAOKA, Kawasaki (JP); Atsushi SOMETANI, Kawasaki (JP)

(73) Assignee: FUJITSU LIMITED, Kawasaki-shi (JP)

(21) Appl. No.: 17/729,713

(22) Filed: Apr. 26, 2022

(30) Foreign Application Priority Data
Jul. 2, 2021 (JP) 2021-110877

(51) Int. Cl. G06F 8/65

(52) U.S. Cl. CPC G06F 8/65

(57) ABSTRACT

A computer system comprises a management apparatus and a plurality of information processing apparatuses each including a peripheral device. The management apparatus includes a memory, and a processor coupled to the memory and configured to: compare version number information of firmware of the peripheral device mounted on each of the plurality of information processing apparatuses with reference information previously set; and in a case where the version number information of firmware is not consistent with the reference information, update firmware of the information processing apparatus so that a version number of firmware of the information processing apparatus becomes consistent with a version number of the reference information.

### CROSS-REFERENCE TO RELATED APPLICATION

This application is based upon and claims the benefit of priority of the prior Japanese Patent Application No. 2021-110877, filed on Jul. 2, 2021, the entire contents of which are incorporated herein by reference.

### FIELD

The embodiment discussed herein is related to a computer system and a control method for firmware version management.

### BACKGROUND

In many cases, a server performs booting by using an operating system (OS) file stored in a storage device installed in the server. However, in recent years, along with the popularization of various network interfaces and trend of improvement in server resource efficiency, a network boot method has been widely used in which OS files are collectively stored in a file server or an external storage device, and an OS logical drive is allocated to each server via a network.

FIG. 26 is a diagram exemplifying a computer system that implements the network boot method of related art. The computer system includes a plurality of servers and a file server or an external storage device.

The file server or the external storage device discloses logical drives (OSs #1 to #3) storing an OS file to the servers via a network. Hereinafter, the file server or the external storage device is simply referred to as a file server. A plurality of OS types or a plurality of OS versions may be installed in the file server.

In the network boot method, each server recognizes an OS as a logical volume. A logical volume may be used not only by one server but also exclusively by another server. FIG. 27 is a diagram for explaining processing of a server in the network boot method of related art. Each server includes a central processing unit (CPU) and a network interface card (NIC). A server is coupled to a file server via an NIC.

An NIC includes a Peripheral Component Interconnect Express (PCIe) extension read-only memory (ROM), and a boot code is stored in the ROM space. An NIC includes a controller and a local area network (LAN) controller. In the network boot method, when a server performs booting (before activation of an OS), a CPU reads a boot code stored in a PCIe extension ROM space in an NIC (reference sign (i) in FIG. 27).

Based on the read boot code, the server performs network setting for the LAN controller of the NIC (reference sign (ii) in FIG. 27). The server requests, via the network, the file server to transfer the OS file to be used for booting processing (reference sign (iii) in FIG. 27).

Japanese Laid-open Patent Publication No. 2009-140194 is disclosed as related art.

### SUMMARY

According to an aspect of the embodiments, a computer system comprising a management apparatus and a plurality of information processing apparatuses each including a peripheral device, wherein the management apparatus including a memory, and a processor coupled to the memory and configured to: compare version number information of firmware of the peripheral device mounted on each of the plurality of information processing apparatuses with reference information previously set; and in a case where the version number information of firmware is not consistent with the reference information, update firmware of the information processing apparatus so that a version number of firmware of the information processing apparatus becomes consistent with a version number of the reference information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a hardware configuration of a computer system as an example of an embodiment;

FIG. 2 is a functional configuration diagram of the computer system as an example of the embodiment;

FIG. 3 is a diagram exemplifying a computer system configured as an active/standby system;

FIG. 4 is a diagram exemplifying an environment master table in the computer system as an example of the embodiment;

FIG. 5 is a diagram exemplifying an FW update file table in the computer system as an example of the embodiment;

FIG. 6 is a sequence diagram for explaining an overview of processing in the computer system as an example of the embodiment;

FIG. 7 is a sequence diagram for explaining an overview of processing in the computer system as an example of the embodiment;

FIG. 8 is a flowchart illustrating a method of creating the environment master table in the computer system as an example of the embodiment;

FIG. 9 is a flowchart for explaining update processing of the environment master table in the computer system as an example of the embodiment;

FIG. 10 is a diagram exemplifying the environment master table in the computer system as an example of the embodiment;

FIG. 11 is a flowchart for explaining device scan processing and update processing of a device information table in each server of the computer system as an example of the embodiment;

FIG. 12 is a diagram exemplifying the device information table in the computer system as an example of the embodiment;

FIG. 13 is a flowchart for explaining processing by a control unit and a table management unit of a file server in the computer system as an example of the embodiment;

FIG. 14 is a diagram exemplifying the environment master table in the computer system as an example of the embodiment;

FIG. 15 is a flowchart for explaining update processing of the environment master table by the table management unit in the file server of the computer system as an example of the embodiment;

FIG. 16 is a diagram exemplifying the environment master table in the computer system as an example of the embodiment;

FIG. 17 is a flowchart for explaining FW update processing in a server of the computer system as an example of the embodiment;

FIG. 18 is a diagram exemplifying the device information table updated along with an FW update in the computer system as an example of the embodiment;

FIG. 19 is a flowchart for explaining FW update processing by a firmware update execution unit in the computer system as an example of the embodiment;

FIG. 20A and FIG. 20B are flowcharts for explaining processing of an active server as a switching source and processing of the file server at the time of system switching of the active server in the computer system as an example of the embodiment;

FIG. 21 is a diagram exemplifying the environment master table in the computer system as an example of the embodiment;

FIG. 22 is a diagram exemplifying the environment master table in the computer system as an example of the embodiment;

FIG. 23 is a flowchart for explaining processing of a standby server as a switching destination at the time of system switching of the active server in the computer system as an example of the embodiment;

FIG. 24 is a diagram illustrating a modification example of the configuration of the computer system as an example of the embodiment;

FIG. 25 is a sequence diagram for explaining an overview of processing in a computer system configured as a cluster system as the modification example of the embodiment;

FIG. 26 is a diagram exemplifying a computer system that implements the network boot method of related art; and

FIG. 27 is a diagram for explaining processing of a server in the network boot method of related art.

### DESCRIPTION OF EMBODIMENTS

In a redundant configuration system including a plurality of servers, a server administrator performs update work of device firmware (FW) of each peripheral device and a device driver for the peripheral device incorporated in an OS in order to support a new function or correct a failure of the peripheral device.

However, in rare cases, update omission may occur in the device FW of a peripheral device. In such a case, there may be cases in which a combination of the device FW that is not updated and the device driver that is updated is out of operation guarantee by a manufacturer of the server or the like, and the peripheral device performs abnormal operation. Hereinafter, device FW may be simply referred to as FW.

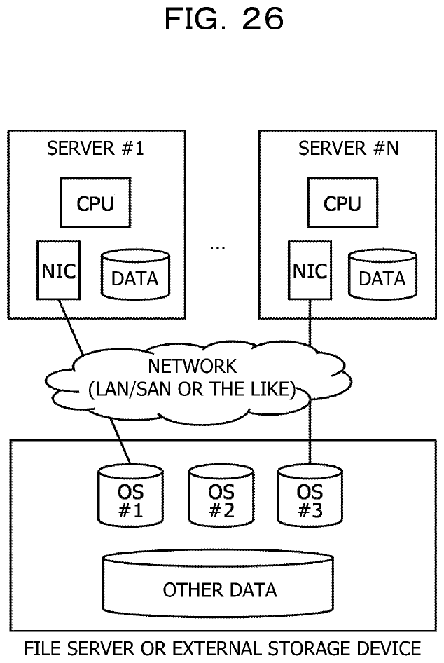

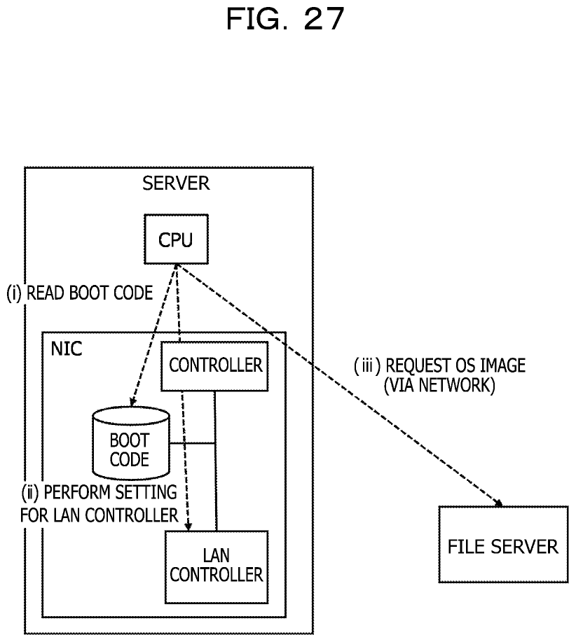

For example, in the computer system illustrated in FIG. 26, it is assumed that the FW of an NIC includes an A version and an A+1 version, and the device driver includes a B version and a B+1 version.

In the B version of the device driver, it is assumed that the operation of the FW of an NIC is guaranteed for the A version or later, for example, both the A version and the A+1 version of the FW.

On the other hand, in the B+1 version of the device driver, it is assumed that the operation of an NIC with the A+1 version of the FW is guaranteed, but the operation of an NIC with the A version of the FW is not guaranteed.

In such a case, when the FW of each NIC provided in a plurality of servers is updated from the A version to the A+1 version, there is a possibility that omission of FW update occurs in some servers for some reason, and the FW of some servers is still the A version.

In such a case, when the device driver of a server is updated and the device driver is updated from the B version to the B+1 version, there is a possibility that the operation of the NIC whose FW is still the A version is not guaranteed, and a failure occurs.

According to one aspect, the present disclosure aims to suppress inconsistency between a device driver and firmware.

The embodiment of the computer system and control method is explained below with reference to the drawings. However, the following embodiment is merely an example and does not intend to exclude application of various modification examples and techniques that are not explicitly described in the embodiment. For example, the present embodiment may be carried out while being modified in various ways (such as combining the embodiment and the modification examples) without departing from the gist of the embodiment. The drawings are not provided with an intention that only the components illustrated in the drawings are included, and other functions and the like may be included.

### (A) Configuration

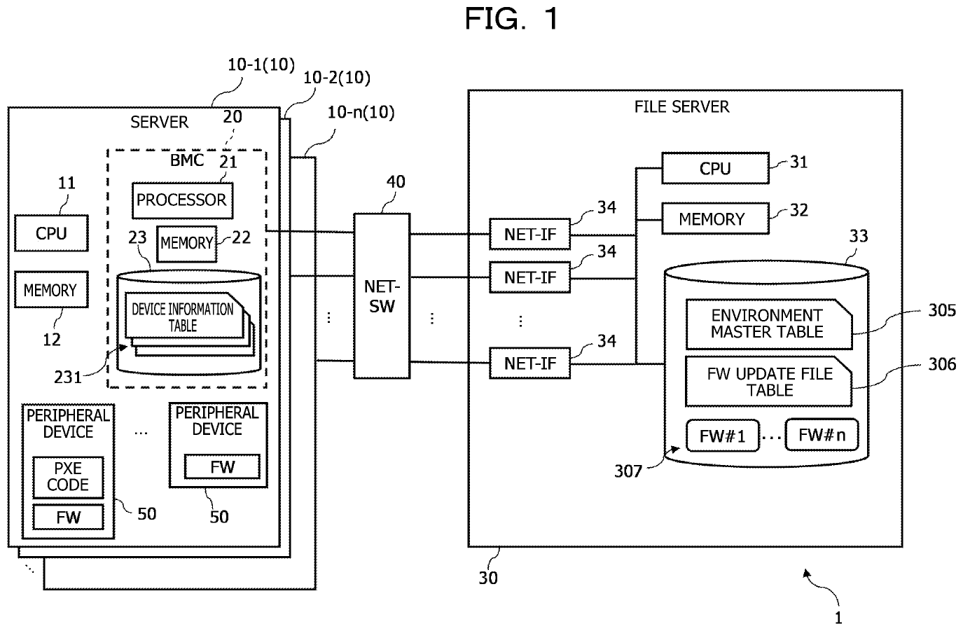

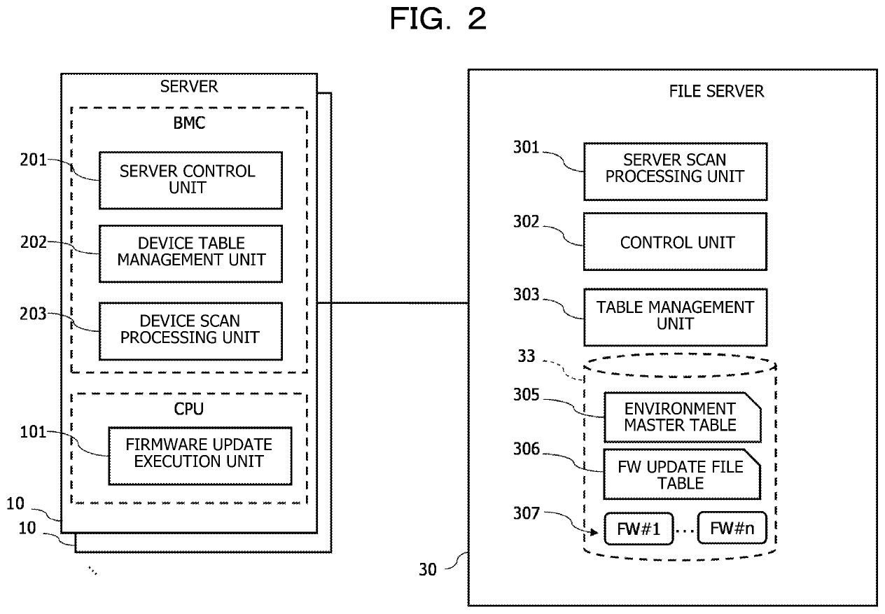

FIG. 1 is a diagram schematically illustrating the hardware configuration of a computer system 1 as an example of the embodiment, and FIG. 2 is a functional configuration diagram thereof.

As illustrated in FIG. 1, the computer system 1 includes a file server 30 and a plurality of (n in the example illustrated in FIG. 1) servers 10-1 to 10-n. The file server 30 and the servers 10-1 to 10-n are mutually communicably coupled via a network switch (NET-SW) 40. For example, the network switch 40 is a LAN switch. Hereinafter, when the servers 10-1 to 10-n are not particularly distinguished, they are referred to as the server 10.

An example in which the computer system 1 is an active/standby system will be described below.

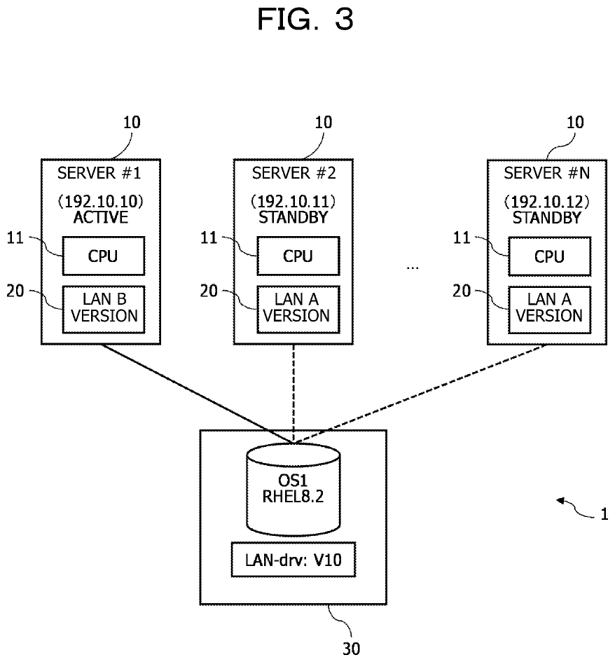

FIG. 3 is a diagram exemplifying the computer system 1 configured as an active/standby system.

An active/standby system includes a plurality of servers 10 having the same configuration, and one server 10 among the plurality of servers 10 is set to be active and the other servers 10 are set to be in a standby state. Hereinafter, among the plurality of servers 10, a server that is active is referred to as an active server 10, and a server that is in a standby state is referred to as a standby server 10.

The failure resistance may be improved by switching the function as the active server 10 to the standby server 10 and taking over the processing in a case where any failure is detected in the active server 10.

For example, the computer system 1 is configured as a redundant system including the plurality of servers 10.

In the computer system 1, each of the plurality of servers 10 performs network booting for activation by accessing a logical drive in which an OS file is stored (hereinafter referred to as an OS logical drive) via a network. At this time, the plurality of servers 10 perform the task by exclusively using the OS logical drive.

The computer system 1 exemplified in FIG. 3 includes N servers #1 to #N, where the server #1 is the active server 10 and the servers #2 to #N are the standby servers 10.

Each server 10 accesses an OS logical drive provided by the file server 30 and is activated by network booting. The file server 30 may provide a plurality of OS types or a plurality of OS versions.

In a case where any failure is detected in the active server #1, any one of the standby servers #2 to #N is determined as the new active server 10, and is network-booted by using the OS logical drive managed by the file server 30, thereby functioning as the new active server 10. An OS logical drive may be referred to as a network booting coupling drive. Network booting may be referred to as net booting.

When performing network booting, a firmware update execution unit 101 (described later with reference to FIG. 2) of the server 10 acquires an address of a network booting coupling drive, acquires a program and data to be used for activation of the server 10 by accessing the address, and achieves the network booting.

The server 10 is a computer having a server function, and includes, as illustrated in FIG. 1, a CPU 11, a memory 12, a baseboard management controller (BMC) 20, and one or more peripheral devices 50.

The peripheral device 50 is an electronic device that is mounted on the server 10 for adding a function to the server 10. For example, the peripheral device 50 is a LAN interface, or a device such as a PCIe card, an NIC, a hard disk drive (HDD), or a solid-state drive (SSD).

Device FW that controls the operation of the peripheral device 50 is stored in the peripheral device 50. The device FW may be updated as desired. A pre-boot execution environment (PXE) code may be stored in an extension ROM space of the peripheral device 50 in an NIC or the like that supports network booting.

A storage device such as an HDD or SSD provided as the peripheral device 50 stores various data and programs to be processed by the CPU 11 described later.

The memory 12 is a storage memory including a ROM and a random-access memory (RAM). A software program for implementing a function to be executed by the server 10 and pieces of data for the program are written in the ROM of the memory 12. The software program on the memory 12 is appropriately read and executed by the CPU 11. The RAM of the memory 12 is used as a primary storage memory or a working memory.

The CPU 11 is a processing device that performs various kinds of control or calculation, and implements various functions by executing the OS and the program stored in the memory 12.

For example, at the time of activation of the server 10, the CPU 11 reads the OS at the time of activation, and performs basic input/output control on the coupled peripheral device 50, and the like, by executing a Basic Input/Output System (BIOS).

By executing the BIOS, the CPU 11 functions as the firmware update execution unit 101 (see FIG. 2). The firmware update execution unit 101 updates the device FW of the peripheral device 50 in cooperation with a server control unit 201 operating on the BMC 20 described later.

The network booting function executed by the BIOS is included in the PXE code installed in the peripheral device 50, and is transferred from the peripheral device 50 to the CPU 11 at the time of activation of the server 10.

The program (BIOS) for implementing the function as the firmware update execution unit 101 is provided in a form of being recorded on a computer-readable recording medium such as, for example, a flexible disk, a compact disc (CD) such as a CD-ROM, a CD-recordable (CD-R), or a CD-rewritable (CD-RW), a Digital Versatile Disc (DVD) such as a DVD-ROM, a DVD-RAM, a DVD-R, a DVD+R, a DVD-RW, a DVD+RW, or high-definition (HD) DVD, a Blu-ray disc, a magnetic disk, an optical disc, or a magneto-optical disk. A computer reads the program from the recording medium, transfers the read program to an internal or external storage device, causes the program to be stored in the internal or external storage device, and uses the program. The program may be recorded in a storage device (recording medium) such as, for example, a magnetic disk, an optical disc, or a magneto-optical disk, and may be provided from the storage device to the computer via a communication channel.

When implementing the function as the firmware update execution unit 101, the program (BIOS) stored in the internal storage device (the memory 12 in the present embodiment) is executed by a microprocessor (the CPU 11 in the present embodiment) of the computer. At this time, the computer may read and execute the program recorded on the recording medium.

The firmware update execution unit 101 performs FW update of the server 10 in which the firmware update execution unit 101 is included (own server 10). The firmware update execution unit 101 acquires an FW update file from the server control unit 201 of the BMC 20 described later and executes the FW update file, thereby updating the FW of the peripheral device 50.

When the update of the FW is completed, for example, the firmware update execution unit 101 sets a flag (normal end flag) indicating a normal end of the FW update in a predetermined storage area of the memory 12 or another storage device (not illustrated). When the update of the FW is not normally completed, for example, the firmware update execution unit 101 sets a flag (abnormal end flag) indicating an abnormal end of the FW update in a predetermined storage area of the memory 12 or another storage device (not illustrated).

When a normal end flag or an abnormal end flag is set in the storage area of the memory 12 or the like, the server control unit 201 of the server 10 described later determines that the FW update is completed. Hereinafter, when a normal end flag and an abnormal end flag are not particularly distinguished from each other, a flag may be referred to as a normal/abnormal end flag.

A simple OS having a minimum function for updating firmware in the server 10 is included in the FW update file executed by the firmware update execution unit 101. By using the simple OS in the FW update file, the firmware update execution unit 101 may activate the own server 10.

The BMC 20 is a monitoring control device (controller) that performs monitoring and maintenance of the server 10 (own server 10) in which the BMC 20 is installed.

As illustrated in FIG. 1, the BMC 20 includes a processor 21, a memory 22, and a storage device 23.

The memory 22 is a storage memory including a ROM and a RAM. A software program for implementing a function to be executed by the BMC 20 and pieces of data for the program are written in the ROM of the memory 22. The software program on the memory 22 is appropriately read and executed by the processor 21. The RAM of the memory 22 is used as a primary storage memory or a working memory.

The storage device 23 is a storage device such as an HDD, SSD, or a storage class memory (SCM), and stores various data. A device information table 231 described later is stored in the storage device 23.

The processor (processing unit) 21 controls the entire BMC 20. The processor 21 may be a multiprocessor. For example, the processor 21 may be any one of a CPU, a microprocessor unit (MPU), a digital signal processor (DSP), an application-specific integrated circuit (ASIC), a programmable logic device (PLD), and a field-programmable gate array (FPGA). The processor 21 may be a combination of two or more types of elements among the CPU, the MPU, the DSP, the ASIC, the PLD, and the FPGA.

By the processor 21 executing the control program for the BMC 20, functions as the server control unit 201, a device table management unit 202, and a device scan processing unit 203 illustrated in FIG. 2 are implemented.

The program (control program) for implementing the functions as the server control unit 201, the device table management unit 202, and the device scan processing unit 203, is provided in a form of being recorded on a computer-readable recording medium such as, for example, a flexible disk, a CD such as a CD-ROM, a CD-R, or a CD-RW, a DVD such as a DVD-ROM, a DVD-RAM, a DVD-R, a DVD+R, a DVD-RW, a DVD+RW, or an HD DVD, a Blu-ray disc, a magnetic disk, an optical disc, or a magneto-optical disk. A computer reads the program from the recording medium, transfers the read program to an internal or external storage device, causes the program to be stored in the internal or external storage device, and uses the program. The program may be recorded in a storage device (recording medium) such as, for example, a magnetic disk, an optical disc, or a magneto-optical disk, and may be provided from the storage device to the computer via a communication channel.

When implementing the functions as the server control unit 201, the device table management unit 202, and the device scan processing unit 203, the program stored in the internal storage device (the memory 22 in the present embodiment) is executed by a microprocessor (the processor 21 in the present embodiment) of the computer. At this time, the computer may read and execute the program recorded on the recording medium.

The server control unit 201 performs overall control of the own server 10. For example, the server control unit 201 executes FW update of the peripheral device 50 in response to an FW update request from the file server 30 in cooperation with the file server 30 and the BIOS operating on the CPU 11.

In response to a request (server device scan request) from the file server 30, the server control unit 201 issues a device scan instruction for instructing the device scan processing unit 203 to collect information (device information) on the FW of the peripheral device 50 mounted on the own server 10.

For example, the information (device information) on the FW of the peripheral device 50 includes information for identifying the peripheral device 50 and information indicating the version number of the FW (device FW version number information). For example, the information for identifying the peripheral device 50 may include a PCI identifier (PCIID), a device ID (DID), and a vendor ID (VID). Collection of device information by the device scan processing unit 203 in the server 10 may be referred to as device scan.

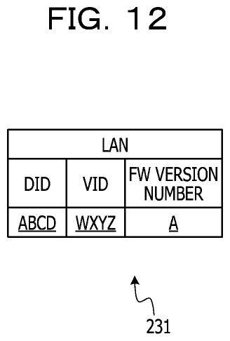

After the device scan by the device scan processing unit 203 is completed, the server control unit 201 causes the device table management unit 202 to register the device information collected by the device scan processing unit 203 in the device information table 231. For example, the device information table 231 may be a combination of DID, VID, and FW version number (see FIG. 12).

The server control unit 201 instructs the device table management unit 202 to register, refer to, and update data in the device information table 231. The instruction of registering, referring to, and updating data in the device information table 231 may be referred to as an access instruction to the device information table 231.

The server control unit 201 provides the device information table 231 to the file server 30. For example, when receiving a transmission request of the device information table 231 (device information table transmission request) from a server scan processing unit 301 of the file server 30, the server control unit 201 provides the device information table 231 to the file server 30 in response to the transmission request.

When an FW update request is issued from a control unit 302 of the file server 30, the server control unit 201 receives a device FW update file from the file server 30 (control unit 302). The server control unit 201 instructs the firmware update execution unit 101 to execute the device FW update file.

Before causing the firmware update execution unit 101 to execute the device FW update file, the server control unit 201 may confirm permission of the execution of the device FW update file with a server administrator or the like.

After the execution of the device FW update file by the firmware update execution unit 101 is completed, for example, after the update of the FW of the peripheral device 50 is completed, the server control unit 201 causes the device scan processing unit 203 to perform the device scan again.

After the update of the FW of the peripheral device 50 is completed, the server control unit 201 transmits an FW update completion response and the recreated device information table 231 to the file server 30.

In a case where the update of the FW of the peripheral device 50 may not be completed for some reason, the server control unit 201 transmits an FW update abnormal end response to the file server 30.

When any abnormality is detected in the own server 10, the server control unit 201 may notify the file server 30 of a system coupling end request or a system switching request. The system coupling end request is a request for ending the coupling of the server 10 with the computer system 1, and the system switching request is a request for setting the standby server 10 as the new active server 10 in place of the own server 10 (active server 10).

The device scan processing unit 203 collects information (device information) on the peripheral device 50 mounted on the own server 10 in accordance with a device scan instruction issued from the server control unit 201.

For example, the device scan processing unit 203 may make an inquiry about device information to the peripheral device 50, and acquire device information provided by the peripheral device 50 in response to the inquiry. The device scan processing unit 203 may read device information by reading setting information related to the peripheral device 50 stored in a predetermined storage area of a register of the peripheral device 50, the storage device 23 of the own server 10, or the like. The way of collecting device information may be changed as appropriate.

The device scan processing unit 203 may collect information on the peripheral device 50 mounted on the own server 10 and store the information in a storage device or the like (not illustrated), at predetermined timing such as when the own server 10 is activated or when the configuration of the peripheral device 50 is changed. When receiving a device FW version number information collection instruction issued from the server control unit 201, the device scan processing unit 203 may provide the information stored in advance in the storage device as described above.

The device table management unit 202 manages the device information table 231. The device table management unit 202 registers data in the device information table 231 and reads data from the device information table 231.

For example, the device table management unit 202 registers the device information of the own server 10 collected by the device scan processing unit 203 in the device information table 231.

The device table management unit 202 registers, refers to, and updates data in the device information table 231, in response to an access instruction made by the server control unit 201 to access the device information table 231.

The file server 30 is a computer having a file management function, and provides data to and performs other communication with the plurality of servers 10 coupled via a network, and the like.

As illustrated in FIG. 1, the file server 30 includes a CPU 31, a memory 32, a storage device 33, and a network interface (NET-IF) 34.

The network interface 34 is a communication interface that enables communication with the server 10 or the BMC 20 installed in the server 10. In the example illustrated in FIG. 1, the file server 30 includes a plurality of network interfaces 34. The file server 30 is coupled to the network switch 40 via the network interface 34. The plurality of servers 10 and the BMC 20 of each server 10 are coupled to the network switch 40. For example, the file server 30 is communicably coupled to the plurality of servers 10 and the plurality of BMCs 20 via the network interface 34 and the network switch 40.

In the computer system 1, the file server 30 is coupled, via the network interface 34, to a task-related network including the plurality of servers 10 and to a management-related network including the BMC 20 of each server 10.

The memory 32 is a storage memory including a ROM and a RAM. A software program for implementing a function to be executed by the file server 30 (control program for the file server 30) and pieces of data for the program are written in the ROM of the memory 32. The software program on the memory 32 is appropriately read and executed by the CPU 31. The RAM of the memory 32 is used as a primary storage memory or a working memory. The storage device 33 is a storage device such as an HDD, SSD, or SCM, and stores various data.

As illustrated in FIG. 2, the storage device 33 stores an environment master table 305, an FW update file table 306, and one or more FW update files 307. The environment master table 305 and the FW update file table 306 will be described later. The FW update file 307 is data used for installing FW in each peripheral device 50 included in each server 10.

A plurality of types of FW update files 307 corresponding to the types of the peripheral devices 50 are stored in the storage device 33. For the same peripheral device 50, the FW update files 307 corresponding to the FW version numbers are prepared.

The firmware update execution unit 101 described later installs (updates) FW of a desired FW version number by executing the FW update file 307 corresponding to the desired FW version number of the corresponding peripheral device 50 among the plurality of types of FW update files 307.

The CPU 31 is a processing device that performs various kinds of control or calculation, and implements various functions by executing the OS and the program stored in the memory 32. By executing the control program for the file server 30, the CPU 31 implements the functions as the server scan processing unit 301, the control unit 302, and a table management unit 303 as illustrated in FIG. 2.

The program (control program for the file server 30) for implementing the functions as the server scan processing unit 301, the control unit 302, and the table management unit 303, is provided in a form of being recorded on a computer-readable recording medium such as, for example, a flexible disk, a CD such as a CD-ROM, a CD-R, or a CD-RW, a DVD such as a DVD-ROM, a DVD-RAM, a DVD-R, a DVD+R, a DVD-RW, a DVD+RW, or an HD DVD, a Blu-ray disc, a magnetic disk, an optical disc, or a magneto-optical disk. A computer reads the program from the recording medium, transfers the read program to an internal or external storage device, causes the program to be stored in the internal or external storage device, and uses the program. The program may be recorded in a storage device (recording medium) such as, for example, a magnetic disk, an optical disc, or a magneto-optical disk, and may be provided from the storage device to the computer via a communication channel.

When implementing the functions as the server scan processing unit 301, the control unit 302, and the table management unit 303, the program stored in the internal storage device (the memory 32 in the present embodiment) is executed by a microprocessor (the CPU 31 in the present embodiment) of the computer. At this time, the computer may read and execute the program recorded on the recording medium.

The server scan processing unit 301 transmits, to each server 10 coupled to the file server 30, a notification (server device scan request) for requesting transmission of device information of the peripheral device 50 mounted on each server 10, in accordance with an instruction from the control unit 302.

The server scan processing unit 301 transmits a server device scan request and a device information table transmission request to the server 10 that exclusively shares the OS logical drive registered in the environment master table 305, in accordance with an instruction from the control unit 302.

The server scan processing unit 301 functions as a requesting unit that requests the server 10 to collect the FW version number information of the peripheral device 50 to be mounted.

The server scan processing unit 301 may cause the device information table 231 transmitted from each server 10 to be stored in a predetermined storage area of the storage device 33.

The table management unit 303 manages the environment master table 305 and the FW update file table 306 stored in the storage device 33. The environment master table 305 is information indicating the system environment of each server 10 in the computer system 1. The environment master table 305 includes at least version number information of the FW of the peripheral device 50 mounted on each server 10 and information on a device driver corresponding to the peripheral device 50 in the OS of the server 10.

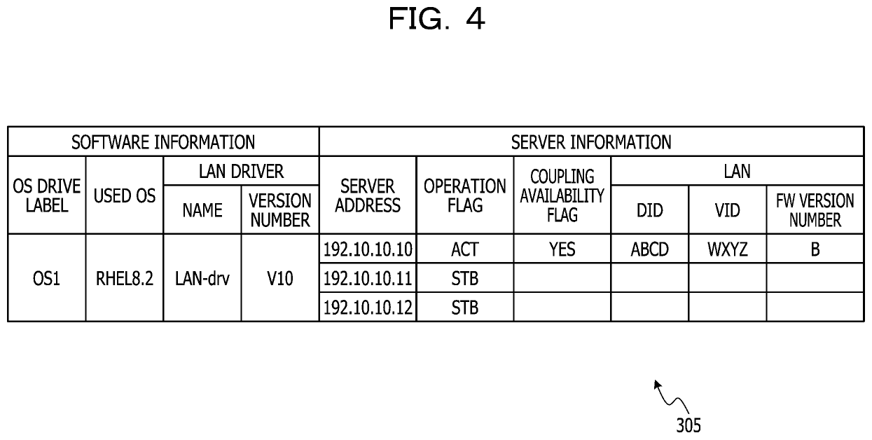

FIG. 4 is a diagram exemplifying the environment master table 305 in the computer system 1 as an example of the embodiment. The environment master table 305 illustrated in FIG. 4 illustrates an example in which the peripheral device 50 mounted on the server 10 is a LAN interface.

The environment master table 305 exemplified in FIG. 4 indicates the values input by a system administrator immediately after the environment of the computer system 1 is constructed. For example, the table represents a state immediately after the environment of the computer system 1 is constructed.

In the environment master table 305 exemplified in FIG. 4, information that is not recognized by the system administrator is left blank. The environment master table 305 exemplified in FIG. 4 includes software information and server information. Software information is information on the software environment in each server 10, and indicates an OS drive label, a used OS, and information on LAN driver (name and version number) in the example illustrated in FIG. 4.

The example illustrated in FIG. 4 indicates that the OS used by the OS logical drive identified by OS drive label “OS1” is RHEL8.2, and that, for the OS1, a LAN driver (device driver) of which the name is “LAN-drv” and the version number is “V10” is included.

Server information indicates the state of the server 10. The example illustrated in FIG. 4 indicates the server address, operation flag, coupling availability flag, and information on LAN interface (peripheral device 50) for each server 10. Information on LAN interface includes device ID (DID), vendor ID (VID), and FW version number.

A server address is information for identifying the server 10, and is, for example, an IP address of the server 10. An operation flag indicates an operation state of the server 10. “ACT” is set when the server 10 is used for operation (active), and “STB” is set when the server 10 is in a standby state. A coupling availability flag indicates whether the server 10 is in a state of being immediately usable. “YES” is set when the server 10 is in a state of being immediately usable, and “NO” is set in when the server 10 is not in a state of being immediately usable.

Hereinafter, among the plurality of servers 10, the server 10 used for operation (active) may be referred to as the active server 10. In the environment master table 305, the server 10 for which “ACT” is set as the operation flag corresponds to the active server 10.

Among the plurality of servers 10, the server 10 in a standby state may be referred to as the standby server 10. In the environment master table 305, the server 10 for which “STB” is set as the operation flag corresponds to the standby server 10.

In the example of the present embodiment, one server 10 among the plurality of servers 10 included in the computer system 1 is the active server 10, and the remaining servers 10 are the standby servers 10.

As described above, for example, immediately after the environment of the computer system 1 is constructed, the system administrator registers the environment master table 305 in the file server 30.

At this time, in the environment master table 305, at least for the active server 10, information of a state in which normal operation is confirmed is registered. For example, in the environment master table 305, it may be said that the information on the active server 10 represents a system configuration (combination of a device driver and the FW version number of the peripheral device 50) with which normal operation is guaranteed.

A system configuration (combination of a device driver and the FW version number of the peripheral device 50) with which normal operation is guaranteed may be referred to as reference information or a golden case. The information on the active server 10 in the environment master table 305 corresponds to a combination of a device driver and FW version number information set in advance.

The FW update file table 306 is information for managing the FW update file 307 of each peripheral device 50.

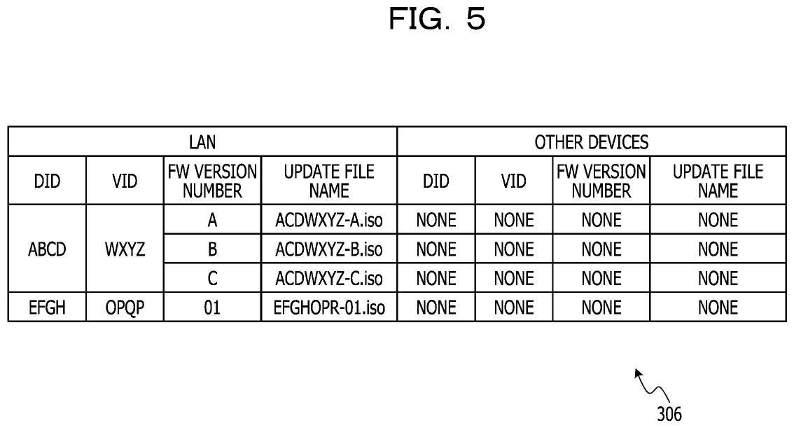

FIG. 5 is a diagram exemplifying the FW update file table 306 in the computer system 1 as an example of the embodiment. The FW update file table 306 exemplified in FIG. 5 indicates information on the FW update file 307 of a LAN interface. In the FW update file table 306 exemplified in FIG. 5, DID, VID, FW version number, and update file name are associated with each other.

For example, the example illustrated in FIG. 5 indicates that there are three types of FW update files 307 with FW version numbers A, B, and C in the FW of the LAN interface with DID “ABCD”, and the file name (update file name) of each FW update file 307 is also indicated. By referring to the FW update file table 306, it is possible to acquire information on the FW update file 307 (update file name) to be used for updating the FW of the peripheral device 50 to a desired version number.

For convenience, in the FW update file table 306 exemplified in FIG. 5, the peripheral devices 50 other than a LAN interface are indicated as “other devices”. As the information on the FW for the other devices, “None” indicating that no value is set is indicated.

The configuration of the FW update file table 306 is not limited to the example illustrated in FIG. 5, and may be changed as appropriate. For example, the FW update file table 306 may manage the storage location of the FW update file 307. The FW update file table 306 may manage the data itself of the FW update file 307.

For example, after the environment of the computer system 1 is constructed, the system administrator registers the FW update file table 306, together with the environment master table 305, in the file server 30.

The table management unit 303 registers, refers to, and updates data in the environment master table 305 and the FW update file table 306 described above, in accordance with an instruction from the control unit 302. For example, the table management unit 303 causes the contents of the device information table 231 of each server 10 provided from the control unit 302 to be reflected in the environment master table 305. The table management unit 303 provides, to the control unit 302 or the like, the data read from the environment master table 305 and the FW update file table 306. The control unit 302 performs overall control in the file server 30.

For example, the control unit 302 performs comparison for an item in the environment master table 305. The control unit 302 makes an alert notification to the system administrator. The control unit 302 refers to the environment master table 305, and performs determination on whether to permit coupling to an OS logical drive, and the like. The control unit 302 requests the server 10 to update the device FW based on the result of the comparison for an item in the environment master table 305.

The control unit 302 instructs the table management unit 303 to register the environment master table 305. The environment master table 305 is created based on a registration instruction given from the system administrator.

The control unit 302 makes an alert notification to the system administrator when detecting an FW update failure, the absence of a system switching destination, or the like.

For example, in a case of a sudden system failure of the active server 10 for some reason, the control unit 302 may perform Keep Alive processing in order to confirm the operation of the active server 10. When timeout of the active server 10 is detected as a result of the Keep Alive processing, the control unit 302 determines that some abnormality such as a system failure has occurred in the active server 10. In such a case, the control unit 302 may perform switching control of allocating, to the server 10 as the switching destination (standby server 10), the OS logical drive that has been previously allocated to the active server 10.

When an instruction to perform update registration for the environment master table 305 is input from the system administrator, the control unit 302 extracts the server 10 that exclusively shares the OS logical drive from the contents of the environment master table 305. The control unit 302 issues a device scan request to each of the extracted servers 10 via the server scan processing unit 301.

When the device information table 231 is provided from each server 10 in response to the device scan request, the control unit 302 causes the table management unit 303 to reflect the contents of the received device information table 231 in the environment master table 305.

Among the servers 10 registered in the environment master table 305, the control unit 302 compares the FW version numbers of the mounted peripheral devices 50 of the same type (same model). For example, the FW version number of the peripheral device 50 mounted on one server 10 is compared with the FW version number of the same peripheral device 50 mounted on another server 10.

The control unit 302 functions as a comparison unit that compares the FW version number of the peripheral device 50 mounted on each of the plurality of servers 10 with preset reference information (combination of a device driver and a device FW version number). The reference information includes the firmware version number of the peripheral device 50 mounted on the active server 10 confirmed to operate normally among the plurality of servers 10.

When the FW version numbers are different from each other as a result of the comparison, the control unit 302 issues an FW update request for the peripheral device 50 to the standby server 10 on which the peripheral device 50 with a different FW version number is mounted so that the different FW version number will be the same as (consistent with) the FW version number of the peripheral device 50 mounted on the active server 10. Here, the term “same” does not necessarily mean completely identical, but may include a specific relationship in which a normal operation of the FW is confirmed.

For example, the control unit 302 functions as an update control unit that, in a case where the version number information of firmware is not the same as the reference information, updates the firmware of the server 10 so that the version number of the firmware of the server 10 is the same as the version number of the reference information.

The server 10 on which the peripheral device 50 with the smaller FW version number of the different FW version numbers is mounted may be referred to as a server 10 to be updated. The FW with the smaller FW version number of the different FW version numbers may be referred to as FW to be updated. The FW with the larger FW version number of the different FW version numbers may be referred to as an update target FW.

Since the configuration of the active server 10 corresponds to the golden case in the environment master table 305, the FW of the peripheral device 50 mounted on the active server 10 may be set as the update target FW.

At the time of issuing the FW update request, the control unit 302 refers to the FW update file table 306 and specifies the FW update file 307 for updating (upgrading) the peripheral device 50 of the server 10 to be updated to the update target FW.

The control unit 302 acquires the specified FW update file 307 and transmits the FW update file to the server 10 to be updated.

When the FW version numbers of the mounted peripheral devices 50 of the same type are the same (have no difference) among the plurality of servers 10 registered in the environment master table 305, the control unit 302 determines that there is no deficiency in the consistency of the FW version numbers, and does not issue the FW update request.

After transmission of the FW update request to the server 10 to be updated, the control unit 302 determines the coupling availability of the server 10 based on the FW update abnormal end response or the FW update completion response transmitted from the server 10 to be updated as the transmission destination.

When the FW update abnormal end response (other than normal end) is received from the server 10 to be updated after transmission of the FW update request to the server 10 to be updated, the control unit 302 causes the table management unit 303 to set, as the coupling availability flag in the environment master table 305, a value “NO” indicating that the server 10 to be updated may not be used as a system switching server. The control unit 302 makes an alert notification to the system administrator indicating that the FW update may not be completed in the server 10 to be updated, and that the server 10 to be updated may not be used as the system switching server.

When the FW update abnormal end response (other than normal end) is received from the server 10 to be updated, the request for coupling to the OS logical drive made from the standby server 10 is rejected at the time of switching the active server 10.

On the other hand, when the FW update completion response is received from the server 10 to be updated after transmission of the FW update request to the server 10 to be updated, the control unit 302 causes the table management unit 303 to set, as the coupling availability flag in the environment master table 305, a value “YES” indicating that the server 10 to be updated may be used as the system switching server.

Instead of determining the coupling availability of the server 10 to be updated based on the FW update abnormal end response or the FW update completion response from the server 10 to be updated, the control unit 302 may determine the coupling availability of the server 10 to be updated based on the device information table 231 provided by the server 10 to be updated. For example, the control unit 302 may compare again the FW version number information registered in the device information table 231 transmitted from the server 10 to be updated with the FW version number in the environment master table 305.

When the FW version numbers are the same as a result of the comparison, the control unit 302 may cause the table management unit 303 to set, as the coupling availability flag in the environment master table 305, a value “YES” indicating that the server 10 to be updated may be used as the system switching server. When the FW version numbers are not the same as a result of the comparison, the control unit 302 may cause the table management unit 303 to set, as the coupling availability flag in the environment master table 305, a value “NO” indicating that the server 10 to be updated may not be used as the system switching server.

The control unit 302 may make an alert notification to the system administrator indicating that the FW update may not be completed in the server 10 to be updated, and that the server 10 to be updated may not be used as the system switching server.

In a case of a sudden system failure of the active server 10 for some reason, the control unit 302 may perform Keep Alive in order to confirm the operation of the active server 10.

In a case of receiving a system coupling end notification from the active server 10, a system switching request from the active server 10, or Keep Alive timeout detection (sudden system failure or the like) of the active server 10, the control unit 302 may perform switching control of allocating, to the server 10 as the switching destination, the OS logical drive that has been previously allocated to the active server 10.

For example, based on the contents of the environment master table 305, the control unit 302 may perform BIOS booting processing of the server 10 (server having no difference in FW version number) set to be capable of system switching in the environment master table 305. Accordingly, the OS logical drive that has been previously allocated to the active server 10 may be allocated to the server 10 as the switching destination.

### (B) Operation

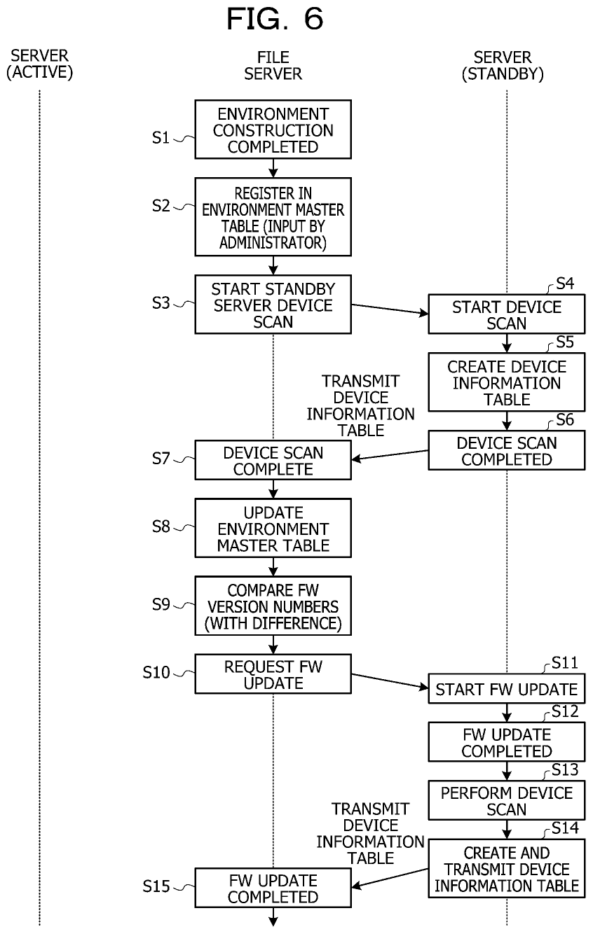

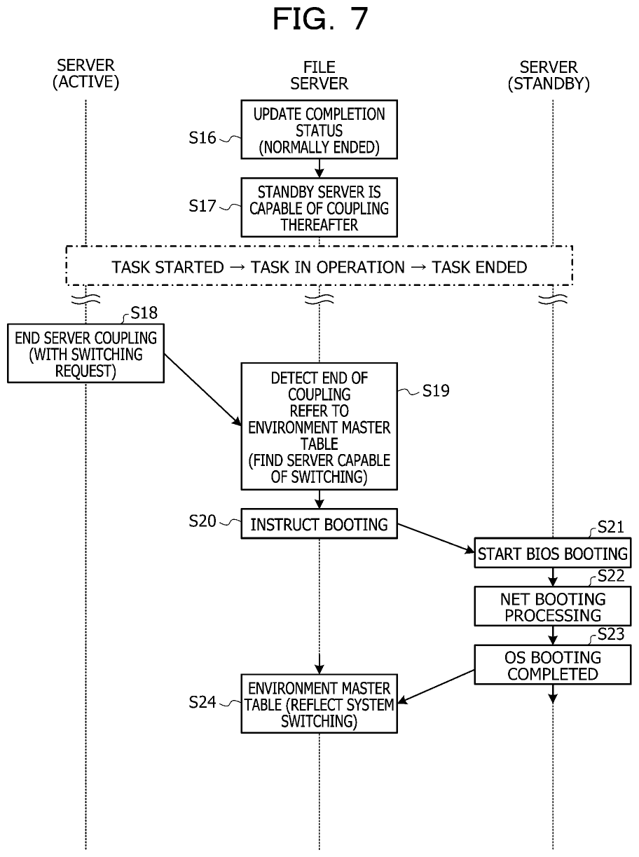

An overview of processing in the computer system 1 as an example of the embodiment configured as described above will be explained with reference to sequence diagrams illustrated in FIGS. 6 and 7. FIG. 6 illustrates the processing of steps S1 to S15, and FIG. 7 illustrates the processing of steps S16 to S24.

First, an environment is constructed in the file server 30 (step S1).

Next, in the file server 30, the system administrator inputs information to be registered in the environment master table 305 (step S2).

In the file server 30, the server scan processing unit 301 transmits a server device scan request to the standby server 10, and starts acquisition of device information of the peripheral device 50 mounted on the standby server 10 (step S3). The server scan processing unit 301 transmits, to the standby server 10, a transmission request of the device information table 231 in which the result of the device scan is reflected.

In the standby server 10, the device scan processing unit 203 starts collection of information (device information) on the peripheral device 50 mounted on the own server 10 in accordance with a device scan instruction issued from the server control unit 201 (step S4).

In the standby server 10, the device table management unit 202 registers the device information of the own server 10 collected by the device scan processing unit 203 in the device information table 231. For example, the device table management unit 202 creates the device information table 231 (step S5).

In the standby server 10, the device scan processing unit 203 completes the collection of device information in the own server 10 (step S6). The device scan processing unit 203 notifies the file server 30 of the completion of the device scan.

The server control unit 201 transmits the device information table 231 created by the device table management unit 202 to the file server 30.

In the file server 30, the control unit 302 receives the device information table 231 from the standby server 10, and completes the device scan of the standby server 10 (step S7).

In the file server 30, the table management unit 303 updates the environment master table 305 by using the received contents of the device information table 231 (step S8).

In the file server 30, the control unit 302 performs comparison for an item (FW version number) in the environment master table 305 (step S9).

When the FW version numbers are different between the peripheral devices 50 of the same type a result of the comparison, the control unit 302 issues an FW update request for the peripheral device 50 to the standby server 10 (step S10). At this time, the control unit 302 transmits, to the standby server 10, an FW update file for achieving FW update in the standby server 10.

When the FW version numbers are the same (have no difference), the control unit 302 determines that there is no deficiency in the consistency of the FW version numbers and does not issue the FW update request, and the processing proceeds to step S16.

In the standby server 10 that has received the FW update request and the FW update file, FW update is performed by the server control unit 201 causing the firmware update execution unit 101 to execute the FW update file 307 (steps S11 and S12).

In the standby server 10, the server control unit 201 issues a device scan instruction to the device scan processing unit 203. The device scan processing unit 203 collects information (device information) of the peripheral device 50 mounted on the own server 10 in accordance with the device scan instruction (step S13).

In the standby server 10, the server control unit 201 causes the device table management unit 202 to register the device information collected by the device scan processing unit 203 in the device information table 231. The device table management unit 202 registers the device information of the own server 10 collected by the device scan processing unit 203 in the device information table 231.

The server control unit 201 provides the device information table 231 to the file server 30 (step S14).

In the file server 30, the control unit 302 receives the notification of FW update completion and the device information table 231 transmitted from the standby server 10, and processes the completion of the FW update of the standby server 10 (step S15). For example, the control unit 302 causes the table management unit 303 to update the FW version number of the peripheral device 50 corresponding to the standby server 10 in the environment master table 305 to a value after the FW update (step S16).

The control unit 302 causes the table management unit 303 to set “YES” as the coupling availability flag of the standby server 10 in the environment master table 305. Accordingly, the standby server 10 is thereafter treated as being capable of coupling.

After that, in the computer system 1, a task using the file server 30 and the active server 10 is started, and the task operation is performed. After that, the task ends.

When any abnormality is detected in the active server 10, the server control unit 201 of the active server 10 ends coupling between the own server 10 and the file server 30 (ends server coupling). At this time, the server control unit 201 notifies the file server 30 of a switching request for setting the standby server 10 as the new active server 10 (step S18).

In the file server 30, the control unit 302 detects the end of coupling of the active server 10. The control unit 302 finds the standby server 10 that is capable of switching as the new active server 10 by referring to the environment master table 305 (step S19).

The control unit 302 determines, as the new active server 10, the standby server 10 for which “YES” is set as the coupling availability flag among the plurality of standby servers 10 in the environment master table 305.

In the file server 30, the control unit 302 issues a booting instruction to the standby server 10 set as the new active server 10 (step S20).

In the standby server 10 that has received the booting instruction, the CPU 11 executes the BIOS to start booting processing (step S21). After that, the standby server 10 is coupled to the OS logical drive via the network and performs network booting processing (step S22). After that, when the OS booting is completed in the standby server 10 (step S23), the server control unit 201 of the standby server 10 notifies the file server 30 of the completion of the OS booting.

In the file server 30, the control unit 302 causes the table management unit 303 to reflect the switching of the active server 10 in the environment master table 305. For example, in the environment master table 305, “ACT” is set as the operation flag for the server 10 that newly becomes the active server 10. “STB” is set as the operation flag for the server 10 that had previously been the active server 10. After that, the processing ends.

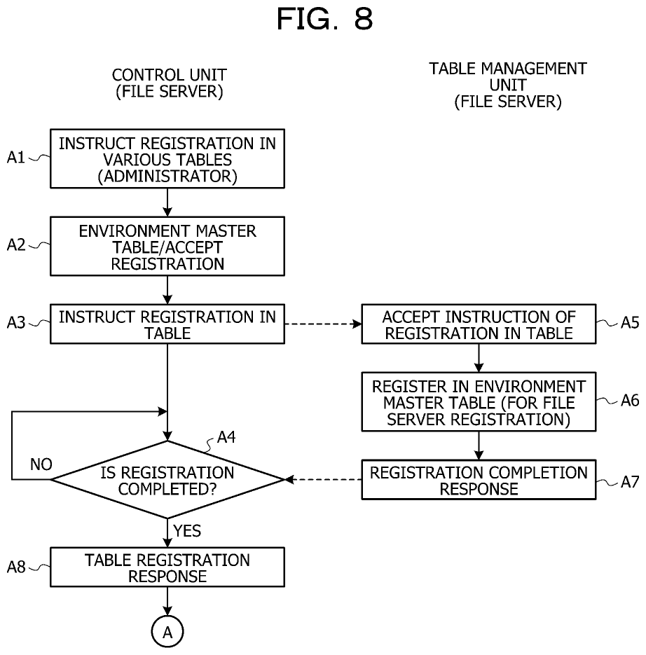

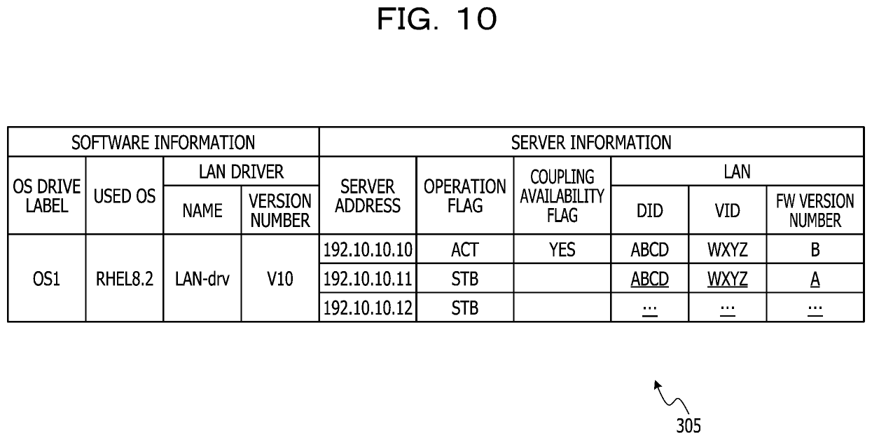

Next, details of processing in the computer system 1 as an example of the embodiment will be explained with reference to the flowcharts illustrated in FIGS. 8, 9, 11, 13, 15, 17, 19, 20, and 23 while referring to FIGS. 10, 12, 14, 16, 18, 21, and 22.

FIG. 8 is a flowchart (steps A1 to A8) illustrating a method of creating the environment master table 305.

In FIG. 8, steps A1 to A4 and A8 indicate processing of the control unit 302 of the file server 30, and steps A5 to A7 indicate processing of the table management unit 303 of the file server 30.

In step A1, the control unit 302 instructs the system administrator to register data in the environment master table 305.

In step A2, the control unit 302 receives data to be registered in the environment master table 305.

In step A3, the control unit 302 instructs the table management unit 303 to register the received data in the environment master table 305.

In step A4, the control unit 302 confirms whether the registration in the environment master table 305 by the table management unit 303 is completed. When the registration in the environment master table 305 is not completed (see NO route in step A4), the processing of step A4 is repeated, and the control unit 302 waits until the registration in the environment master table 305 is completed.

In step A5, the table management unit 303 accepts the instruction to register the data in the environment master table 305 from the control unit 302, and in step A6, registers the data in the environment master table 305.

For the environment master table 305 in a state where data is input by the system administrator, refer to FIG. 4.

In step A7, the table management unit 303 notifies the control unit 302 that the registration of data in the environment master table 305 is completed.

When the registration in the environment master table 305 is completed as a result of the confirmation in step A4 (see YES route in step A4), the processing proceeds to step A8.

In step A8, the control unit 302 notifies the system administrator that the registration in the environment master table 305 is completed.

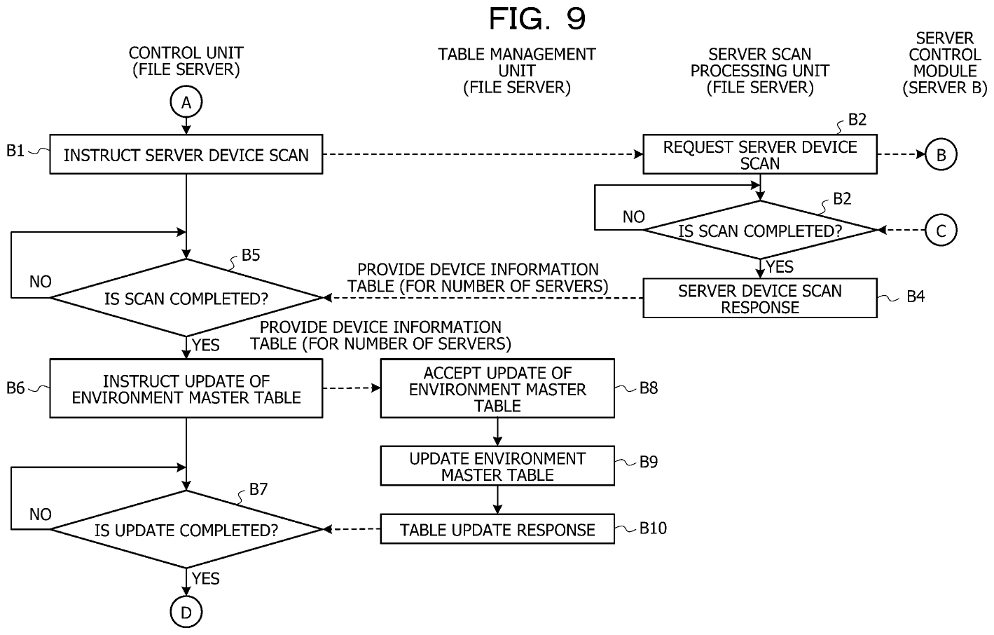

After that, the processing proceeds to step B1 in FIG. 9.

Preferably, the control unit 302 creates the FW update file table 306 (see FIG. 5) in parallel with the creation and registration of the environment master table 305.

FIG. 9 is a flowchart (steps B1 to B10) for explaining update processing of the environment master table 305.

In FIG. 9, steps B1 and B5 to B7 indicate processing of the control unit 302 of the file server 30, and steps B8 to B10 indicate processing of the table management unit 303 of the file server 30. Steps B2 to B4 indicate processing of the server scan processing unit 301 of the file server 30.

In the file server 30, the control unit 302 gives a server device scan instruction of causing the server scan processing unit 301 to issue a server device scan request to each server 10 (step B1).

The control unit 302 confirms whether the device scan is completed in each server 10 (step B5). When the device scan is not completed in all the servers 10 (see NO route in step B5), the control unit 302 repeatedly performs step B5 and waits until the device scan is completed in all the servers 10.

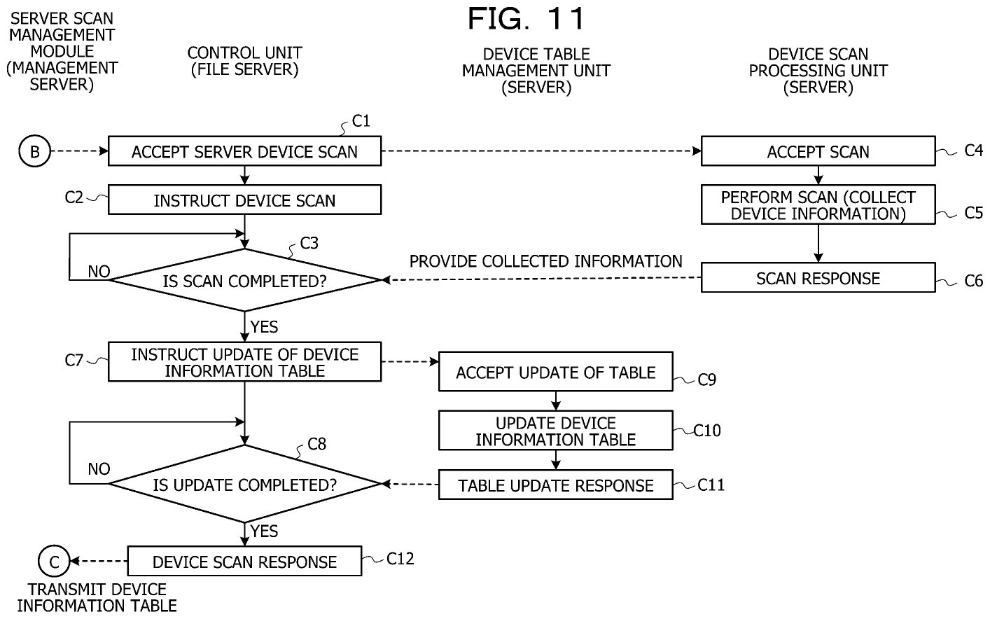

In the file server 30, the server scan processing unit 301 transmits, to each server 10 coupled to the file server 30, a notification (server device scan request) for requesting transmission of device information of the peripheral device 50 mounted on each server 10 (step B2). Details of device scan processing in each server 10 will be described later with reference to FIG. 11.

The server scan processing unit 301 confirms whether the device scan is completed in each server 10 (step B3). For example, when the device information tables 231 are transmitted from all the servers 10 as a response to the device scan request, the server scan processing unit 301 determines that the device scan is completed in all the servers 10.

When the device scan is not completed in all the servers 10 (see NO route in step B3), step B3 is repeatedly performed. When the device scan is completed in all the servers 10 (see YES route in step B3), the processing proceeds to step B4.

The server scan processing unit 301 transmits (provides), to the control unit 302, the device information table 231 provided from each server 10 (step B4). The server scan processing unit 301 may transmit, to the control unit 302, a server device scan response indicating that the device scan is completed in all the servers 10.

When the device information tables 231 of all the servers 10 are transmitted from the server scan processing unit 301, the control unit 302 determines that the device scan is completed in all the servers 10 (see YES route in step B5).

The control unit 302 transmits the device information table 231 of each server 10 to the table management unit 303, and instructs to update the environment master table 305 (step B6).

For each server 10, the control unit 302 confirms whether the update of the environment master table 305 is completed (step B7). When the update of the environment master table 305 is not completed for all the servers 10 (see NO route in step B7), the control unit 302 repeatedly performs step B7 and waits until the update of the environment master table 305 is completed for all the servers 10.

The table management unit 303 accepts the update of the environment master table 305 (step B8), and updates the environment master table 305 by registering the contents of the device information table 231 received from each server 10 in the environment master table 305 (step B9).

FIG. 10 is a diagram exemplifying the updated environment master table 305.

The environment master table 305 exemplified in FIG. 10 indicates a state after being updated by reflecting, for the server 10 with the shared server address of “192.10.10.11”, the contents of the device information table 231 received from the server 10.

The table management unit 303 notifies the control unit 302 that the update of the environment master table 305 is completed (step B10).

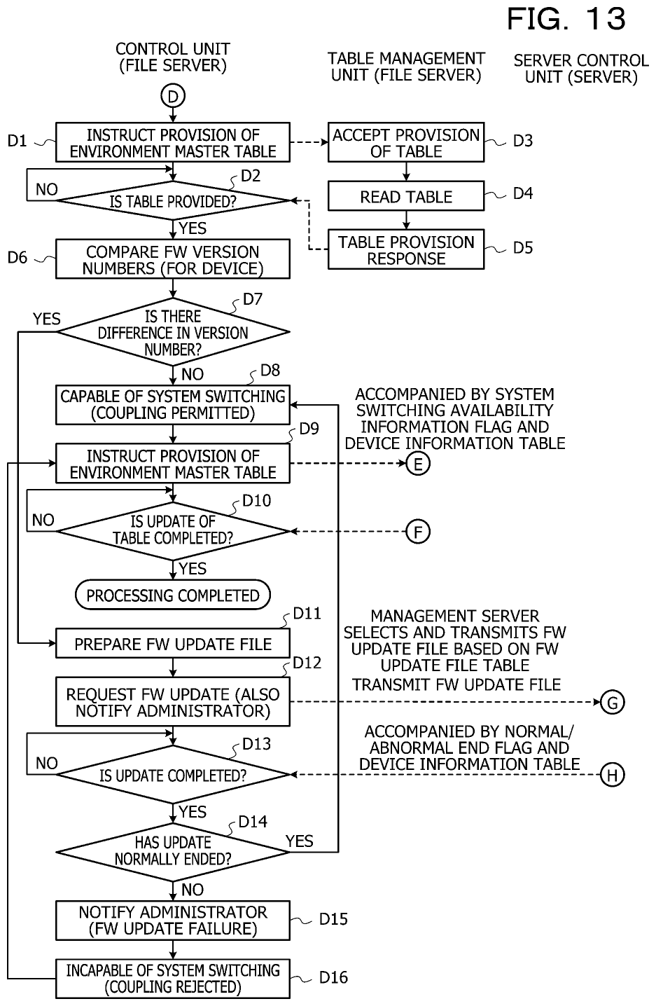

When the notification indicating that the update of the environment master table 305 is completed is transmitted from the table management unit 303, the control unit 302 determines that the update of the environment master table 305 is completed (see YES route in step B7). After that, the processing proceeds to step D1 in FIG. 13. Explanation of processing by the control unit 302 and the table management unit 303 of the file server 30 with reference to FIG. 13 will be given later.

Next, device scan processing and update processing of the device information table 231 in each server 10 will be explained with reference to a flowchart (steps C1 to C12) illustrated in FIG. 11.

In FIG. 11, steps C1 to C3, C7, C8, and C12 indicate processing of the server control unit 201 of the server 10, and steps C9 to C11 indicate processing of the device table management unit 202 of the server 10. Steps C4 to C6 indicate processing of the device scan processing unit 203 of the server 10.

The processing is started by the server scan processing unit 301 of the file server 30 transmitting a server device scan request to the server control unit 201 of each server 10 in step B2 of the flowchart illustrated in FIG. 9.

The server control unit 201 receives the server device scan request from the file server 30 (step C1), and transmits a device scan instruction to each server 10 (step C2).

The server control unit 201 confirms whether the device scan by the device scan processing unit 203 is completed (step C3). When the device scan is not completed (see NO route in step C3), the server control unit 201 repeatedly performs step C3 and waits until the device scan is completed.

The device scan processing unit 203 receives the device scan instruction from the server control unit 201 (step C4), and performs the device scan on the peripheral device 50 included in the own server 10 (step C5). When the device scan is completed, the device scan processing unit 203 provides the collected device information to the server control unit 201 (step C6).

When the device scan in the device scan processing unit 203 is completed and the device information is provided (see YES route in step C3), the server control unit 201 transmits an instruction to update the device information table 231 to the device table management unit 202 (step C7).

The server control unit 201 confirms whether the update of the device information table 231 by the device table management unit 202 is completed (step C8). When the update of the device information table 231 is not completed (see NO route in step C8), the server control unit 201 repeatedly performs step C8 and waits until the update of the device information table 231 is completed.

When receiving the instruction to update the device information table 231 from the server control unit 201 (step C9), the device table management unit 202 updates the device information table 231 by using the device information collected by the device scan processing unit 203 (step C10).

FIG. 12 is a diagram exemplifying the updated device information table 231.

The device information table 231 exemplified in the diagram indicates the device information table 231 for a LAN interface obtained after device scan is performed by the device scan processing unit 203 in the server #2.

The device table management unit 202 notifies (responds to) the server control unit 201 that the update of the device information table 231 is completed (step C11).

When the update of the device information table 231 by the device table management unit 202 is completed (see YES route in step C8), the server control unit 201 transmits the updated device information table 231 to the server scan processing unit 301 of the file server 30 (step C12). After that, the processing proceeds to step B3 in FIG. 9.

Next, processing by the control unit 302 and the table management unit 303 of the file server 30 in the computer system 1 will be explained with reference to a flowchart (steps D1 to D16) illustrated in FIG. 13.

In FIG. 13, steps D1, D2, and D6 to D16 indicate processing of the control unit 302 of the file server 30, and steps D3 to D5 indicate processing of the table management unit 303 of the file server 30.

The processing is started when it is determined in step B7 illustrated in FIG. 9 that the update of the environment master table 305 is completed (see YES route).

The control unit 302 of the file server 30 instructs the table management unit 303 to provide the environment master table 305 (step D1).

The control unit 302 confirms whether the environment master table 305 is provided from the table management unit 303 (step D2). When the environment master table 305 is not provided from the table management unit 303 (see NO route in step D2), the control unit 302 repeatedly performs step D2 and waits until the environment master table 305 is provided from the table management unit 303.

When receiving the instruction to provide the environment master table 305 (step D3), the table management unit 303 reads the environment master table 305 from the storage device 33 (step D4), and provides the read environment master table 305 to the control unit 302 (step D5).

When the environment master table 305 is provided from the table management unit 303 (see YES route in step D2), the control unit 302 compares the FW version numbers of the mounted peripheral devices 50 of the same type among the servers 10 registered in the environment master table 305 (step D6).

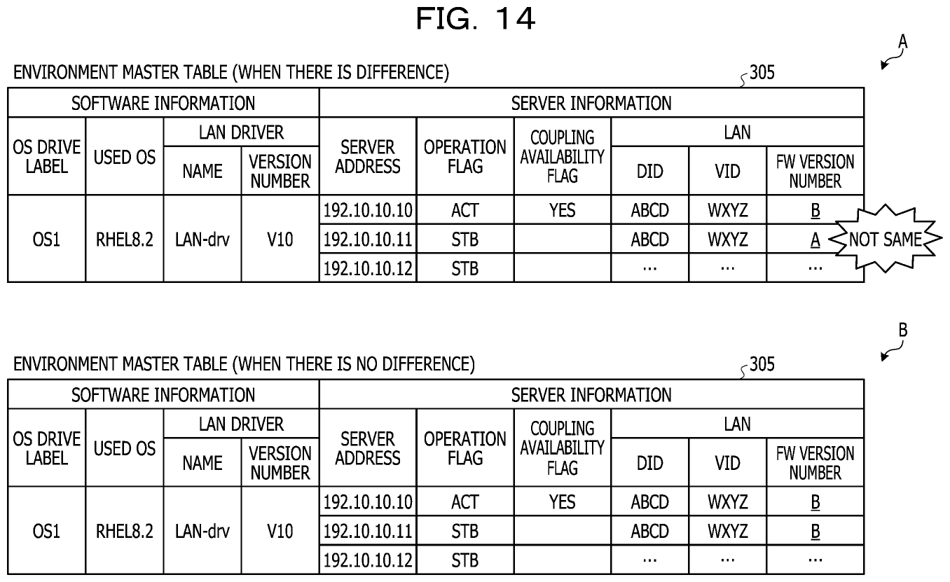

FIG. 14 is a diagram exemplifying the environment master table 305.

In FIG. 14, the environment master table 305 indicated by reference sign A indicates an example in which there is a difference in FW version number between the peripheral devices 50 of the same type. For example, the FW version number of the LAN interface mounted on the server 10 with the server address of “192.10.10.10” is “B”, while the FW version number of the LAN interface mounted on the server 10 with the server address of “192.10.10.11” is “A”, and the numbers are not the same.

By contrast, the environment master table 305 indicated by reference sign B indicates an example in which there is no difference in FW version number between the peripheral devices 50 of the same type.

By referring to the environment master table 305, the control unit 302 confirms whether there is a difference in FW version number between the peripheral devices 50 of the same type (step D7). When there is a difference in FW version number as a result of the confirmation (see YES route in step D7), the control unit 302 prepares the FW update file 307 for resolving the difference (step D11).

For example, the control unit 302 refers to the FW update file table 306, and specifies and acquires the FW update file 307 for updating (upgrading) the FW to be updated to the update target FW.

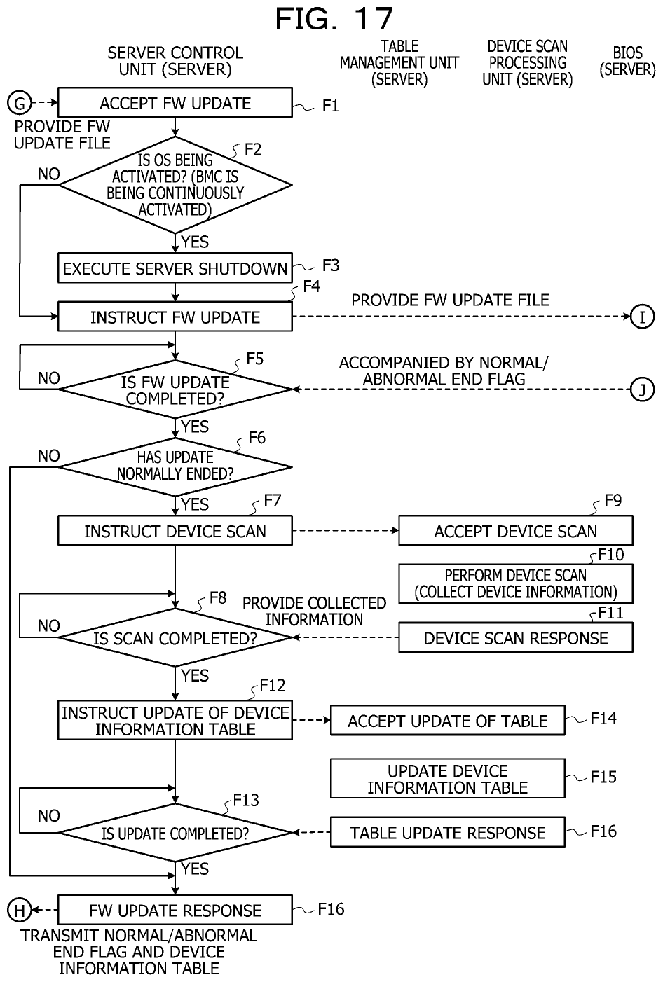

The control unit 302 transmits the FW update file 307 to the server 10 to be updated and makes an FW update request (step D12). Details of FW update processing in the server 10 to be updated will be described later with reference to a flowchart illustrated in FIG. 17.

The control unit 302 may notify the system administrator that the FW update of the server 10 to be updated is performed.

The control unit 302 confirms whether the FW update in the server 10 to be updated is completed (step D13). When the FW update is not completed in the server 10 to be updated (see NO route in step D13), the control unit 302 repeatedly performs step D13 and waits until the FW update is completed in the server 10 to be updated.

For example, when a normal/abnormal end flag for the FW update and the device information table 231 are provided from the server 10 to be updated, the control unit 302 determines that the FW update in the server 10 to be updated is completed.

When the FW update is completed in the server 10 to be updated (see YES route in step D13), the control unit 302 confirms whether the FW update has normally ended (step D14).

When the FW update in the server 10 has not normally ended (see NO route in step D14), the control unit 302 notifies the system administrator that the FW update has failed (step D15). The control unit 302 recognizes the server 10 for which FW update has failed as being incapable of system switching (step D16), and the processing proceeds to step D9.

In step D9, the control unit 302 causes the table management unit 303 to set, as the coupling availability flag in the environment master table 305, a value “NO” indicating that the server 10 may not be used as the system switching server. An instruction given to the table management unit 303 to update the environment master table 305 is accompanied by the device information table 231 together with a value to be set as the coupling availability flag.

The control unit 302 confirms whether the update of the environment master table 305 is completed (step D10). When the update of the environment master table 305 is not completed (see NO route in step D10), the control unit 302 repeatedly performs step D10 and waits until the update of the environment master table 305 is completed.

When the update of the environment master table 305 is completed (see YES route in step D10), the processing ends.

On the other hand, when the FW update in the server 10 has normally ended as a result of the confirmation in step D14 (see YES route in step D14), the control unit 302 recognizes the server 10 for which FW update has normally ended as being capable of system switching (step D8). After that, the processing proceeds to step D9, and the control unit 302 causes the table management unit 303 to set, as the coupling availability flag in the environment master table 305, a value “YES” indicating that the server 10 may be used as the system switching server.

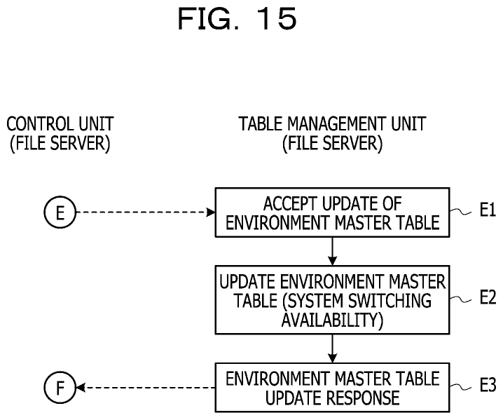

Update processing of the environment master table 305 by the table management unit 303 in the file server 30 will be explained with reference to a flowchart (steps E1 to E3) illustrated in FIG. 15.

The processing is started by the control unit 302 of the file server 30 instructing the table management unit 303 to update the environment master table 305 in step D9 of the flowchart illustrated in FIG. 13.

In step E1, the table management unit 303 receives the instruction to update the environment master table 305.

In step E2, the table management unit 303 sets, as the coupling availability flag in the environment master table 305, a value corresponding to a system switching availability information flag notified from the control unit 302.

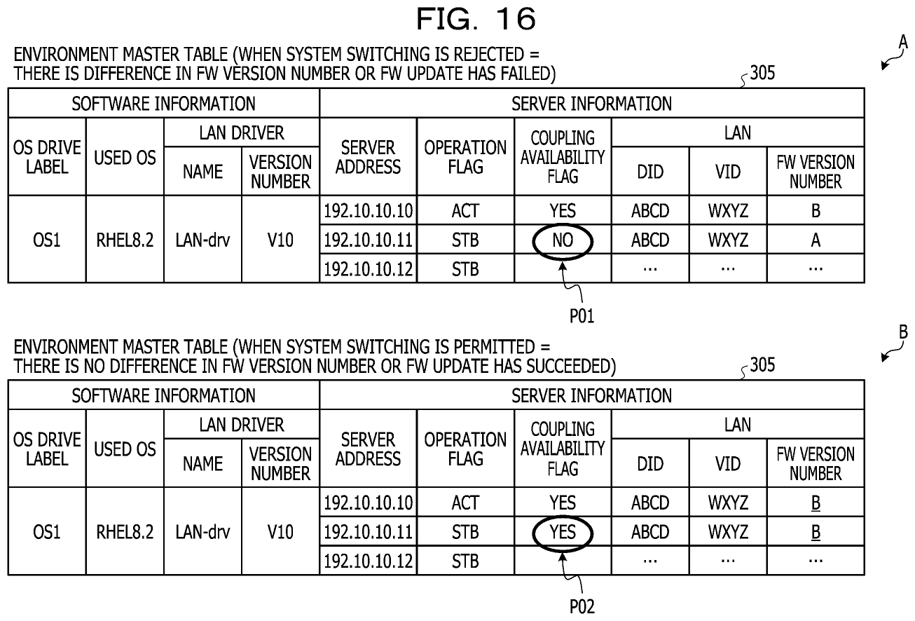

FIG. 16 is a diagram exemplifying the updated environment master table 305.

In FIG. 16, reference sign A indicates the environment master table 305 in which “NO” is set as the coupling availability flag (see reference sign P01), and reference sign B indicates the environment master table 305 in which “YES” is set as the coupling availability flag (see reference sign P02).

In step E3, the table management unit 303 notifies (responds to) the control unit 302 that the update of the environment master table 305 is completed. After that, the processing proceeds to step D10 in FIG. 13.

Next, FW update processing in the server 10 will be explained with reference to a flowchart (steps F1 to F17) illustrated in FIG. 17.

In FIG. 17, steps F1 to F7, F8, F12, F13, and F17 indicate processing of the server control unit 201 of the server 10, steps F9 to F11 indicate processing of the device scan processing unit 203 of the server 10, and steps F14 to F16 indicate processing of the device table management unit 202 of the server 10.

The processing is started by the control unit 302 of the file server 30 instructing the table management unit 303 to update the environment master table 305 in step D12 of the flowchart illustrated in FIG. 13.

The server control unit 201 receives an instruction of FW update together with an FW update file from the control unit 302 of the file server 30 (step F1).

The server control unit 201 confirms whether the OS is being activated in the own server 10 (step F2). The BMC 20 may be continuously activated.

When the OS is being activated (see YES route in step F2), the server control unit 201 executes shutdown of the own server 10 (step F3).

The server control unit 201 provides the FW update file to the firmware update execution unit 101, and instructs the firmware update execution unit 101 to update the FW (step F4).

The server control unit 201 confirms whether the FW update by the firmware update execution unit 101 is completed (step F5). When the FW update is not completed, the server control unit 201 repeatedly performs step F5 and waits until the FW update is completed.

When the firmware update execution unit 101 sets a normal/abnormal end flag in a predetermined storage area of the memory 12 or the like, the server control unit 201 determines that the FW update is completed (see YES route in step F5).

By referring to the value of the normal/abnormal end flag set by the firmware update execution unit 101, the server control unit 201 confirms whether the FW update by the firmware update execution unit 101 has normally ended (step F6). When the FW update has not normally ended (see NO route in step F6), the processing proceeds to step F17.

The server control unit 201 notifies the control unit 302 of the file server 30 of an abnormal end flag for the FW update (step F17). After that, the processing proceeds to step D13 of the flowchart illustrated in FIG. 13.

On the other hand, when the FW update has normally ended (see YES route in step F6), the processing proceeds to step F7.

In step F7, the server control unit 201 instructs the device scan processing unit 203 of the own server 10 to perform device scan. The server control unit 201 confirms whether the device scan by the device scan processing unit 203 is completed (step F8). When the device scan is not completed (see NO route in step F8), the server control unit 201 repeatedly performs step F8 and waits until the device scan is completed.

The device scan processing unit 203 receives the device scan instruction from the server control unit 201 (step F9), and performs the device scan (step F10). The device scan processing unit 203 provides the device information obtained by the device scan to the server control unit 201 (step F11).

When the device scan by the device scan processing unit 203 is completed (see YES route in step F8), the server control unit 201 instructs the device table management unit 202 of the own server 10 to update the device information table 231 (step F12).

The server control unit 201 confirms whether the update of the device information table 231 is completed (step F13). When the update of the device information table 231 is not completed (see NO route in step F13), the server control unit 201 repeatedly performs step F13 and waits until the update of the device information table 231 is completed.

When receiving the instruction to update the device information table 231 (step F14), the device table management unit 202 updates the device information table 231 by using the device information acquired by the device scan processing unit 203 (step F15).

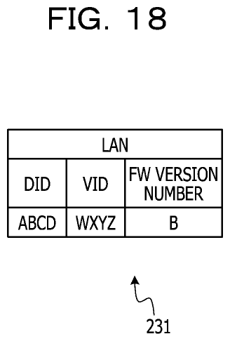

FIG. 18 is a diagram exemplifying the device information table 231 updated along with an FW update.

In the device information table 231 exemplified in FIG. 18, FW version number is updated from A to B.

The device table management unit 202 notifies (responds to) the server control unit 201 that the update of the device information table 231 is completed (step F16).

When the update of the device information table 231 is completed (see YES route in step F13), the server control unit 201 transmits the updated device information table 231 to the control unit 302 of the file server 30 (step F17). The server control unit 201 may transmit a normal/abnormal end flag for the FW update together with the device information table 231. After that, the processing proceeds to step D13 of the flowchart illustrated in FIG. 13.

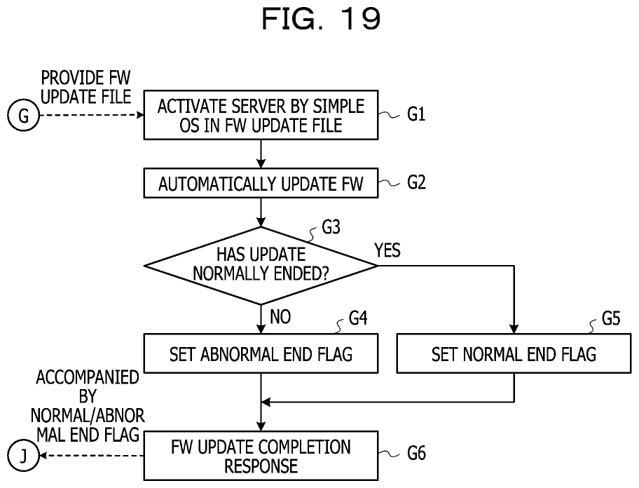

Next, FW update processing by the firmware update execution unit 101 will be explained with reference to a flowchart (steps G1 to G6) illustrated in FIG. 19.

The processing is started by the server control unit 201 giving an instruction of FW update to the firmware update execution unit 101 in step F4 of the flowchart illustrated in FIG. 17.

The server control unit 201 provides an FW update file to the firmware update execution unit 101, and instructs the firmware update execution unit 101 to perform FW update.

A simple OS having a minimum function for updating firmware in the server 10 is included in the FW update file executed by the firmware update execution unit 101. The firmware update execution unit 101 activates the own server 10 by using the simple OS (step G1). After that, the FW is automatically updated (step G2).

The firmware update execution unit 101 confirms whether the FW update has normally ended (step G3). When the FW update has normally ended (see YES route in step G3), the firmware update execution unit 101 sets a normal end flag (step G5). On the other hand, when the FW update has not normally ended (see NO route in step G3), the firmware update execution unit 101 sets an abnormal end flag (step G4).

The firmware update execution unit 101 makes an FW update completion response accompanied by the normal/abnormal end flag to the server control unit 201 (step G6). After that, the processing proceeds to step F5 in FIG. 17.

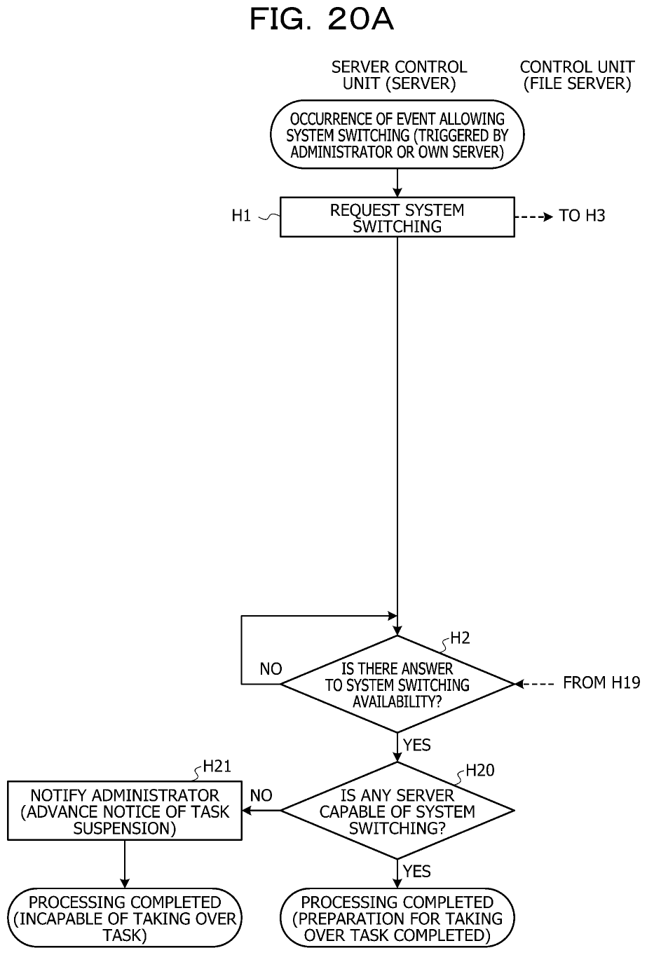

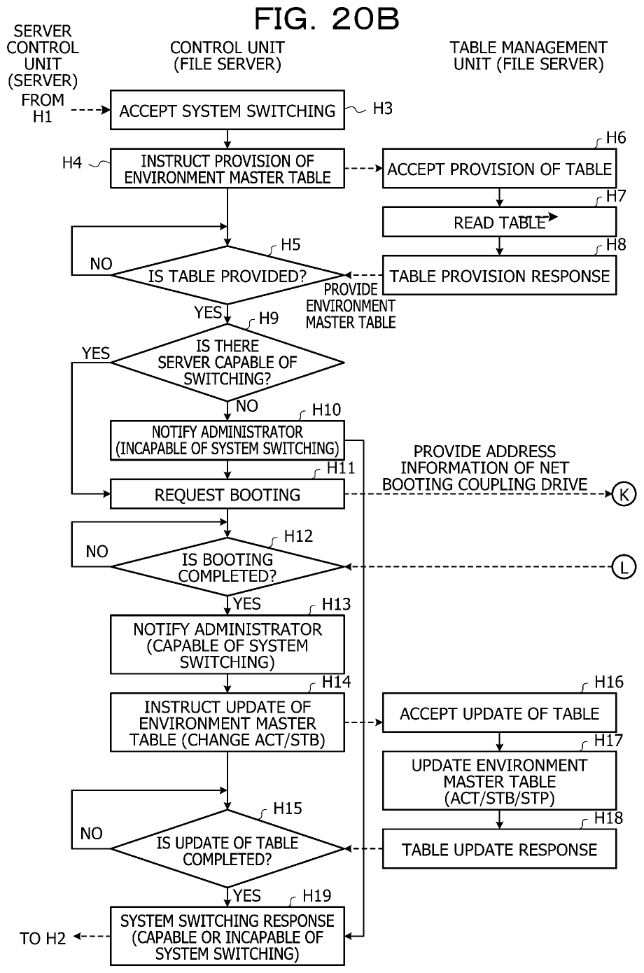

Next, processing of the active server 10 as a switching source and processing of the file server 30 at the time of switching (system switching) of the active server 10 will be explained with reference to a flowchart (steps H1 to H21) illustrated in FIG. 20.

In FIG. 20, steps H1 to H2, H20, and H21 indicate processing of the server control unit 201 of the active server 10. Steps H3 to H5, H9 to H15, and H19 indicate processing of the control unit 302 of the file server 30, and steps H6 to H8 and H16 to H18 indicate processing of the table management unit 303 of the file server 30.

In the active server 10, the server control unit 201 transmits a system switching request to the control unit 302 of the file server 30 (step H1).

The server control unit 201 confirms whether a response to the system switching request is input from the file server 30. When there is no answer (response) to the system switching request (see NO route in step H2), the server control unit 201 repeatedly performs the processing of step H2 and waits until an answer to the system switching request is made from the control unit 302 of the file server 30.

In the file server 30, the control unit 302 receives the system switching request from the active server 10 (step H3), and requests (instructs) the table management unit 303 to provide the environment master table 305 (step H4). The control unit 302 confirms whether the environment master table 305 is provided from the table management unit 303 (step H5).

When the environment master table 305 is not provided from the table management unit 303 (see NO route in step H5), the control unit 302 repeatedly performs step H5 and waits until the environment master table 305 is provided from the table management unit 303.

The table management unit 303 receives the instruction to provide the environment master table 305 (step H6), and reads the environment master table 305 from the storage device 33 (step H7). The table management unit 303 provides the read environment master table 305 to the control unit 302 (step H8).

When the environment master table 305 is provided from the table management unit 303 (see YES route in step H5), the control unit 302 refers to the environment master table 305 and confirms whether there is the server 10 capable of switching (step H9). For example, the control unit 302 confirms whether there is the server 10 for which “YES” is set as the coupling availability flag in the environment master table 305.

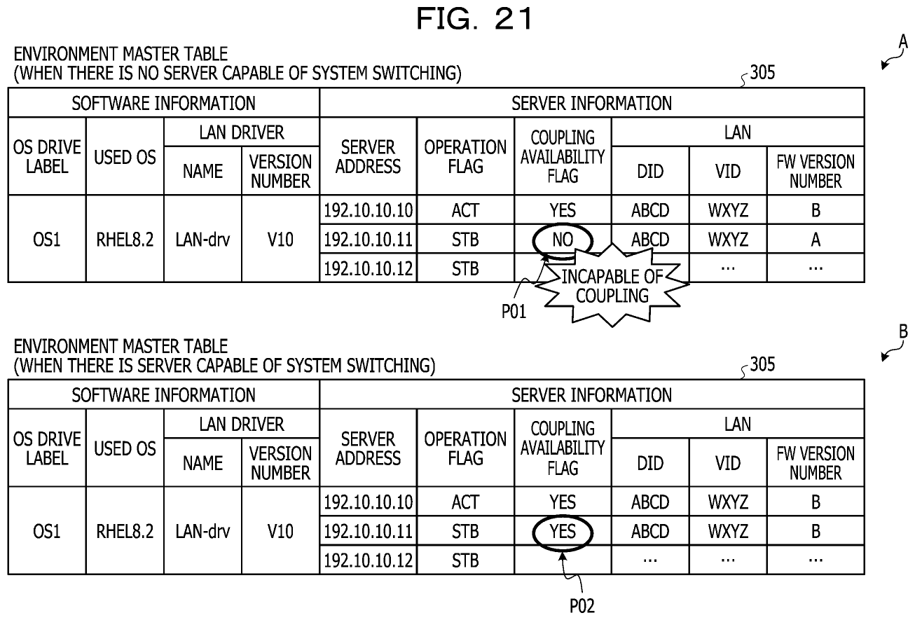

FIG. 21 is a diagram exemplifying the updated environment master table 305.

In FIG. 21, reference sign A indicates the environment master table 305 in which “NO” is set as the coupling availability flag (see reference sign P01), and reference sign B indicates the environment master table 305 in which “YES” is set as the coupling availability flag (see reference sign P02).

The server 10 for which “YES” is set as the coupling availability flag in the environment master table 305 may be referred to as the server 10 capable of switching.

When there is no server 10 capable of switching (see NO route in step H9), the control unit 302 notifies the system administrator that the system switching may not be performed (step H10). For example, a message indicating that the system switching may not be performed may be displayed on a display (not illustrated) as the notification.

After that, the control unit 302 notifies the server control unit 201 of the active server 10 that the system switching may not be performed (step H19).

When receiving an answer indicating that the system switching may or may not be performed (see YES route in step H2), the server control unit 201 of the active server 10 confirms whether the answer indicates that the system switching may be performed (step H20).

When the system switching may not be performed (see NO route in step H20), the server control unit 201 notifies the system administrator that the system switching may not be performed (step H21). The server control unit 201 may give an advance notice of task suspension to the system administrator.

Instead of causing task suspension in step H21, the server control unit 201 of the active server 10 may return to step H1 and transmit the system switching request to the file server 30 in order to cause another standby server 10 to be the switching server. After that, the processing ends as the task may not be taken over.

When there is the server 10 capable of switching as a result of the confirmation in step H9 (see YES route in step H9), the control unit 302 transmits a booting request to the server 10 capable of switching (step H11). In a case where a plurality of servers 10 capable of switching are registered in the environment master table 305, the control unit 302 selects one server 10 capable of switching from among the plurality of servers 10 capable of switching, and transmits the booting request to the selected server 10 capable of switching. For example, the server 10 capable of switching may be randomly selected from among the plurality of servers 10 capable of switching, or may be selected in accordance with a predetermined priority order defined in advance.

The control unit 302 confirms whether the booting of the server 10 capable of switching is completed (step H12). When the booting of the server 10 capable of switching is not completed (see NO route in step H12), the control unit 302 repeatedly performs step H12 and waits until the booting of the server 10 capable of switching is completed.

When completion of the booting is notified from the server 10 capable of switching (see YES route in step H12), the control unit 302 notifies the system administrator that the system switching may be performed (step H13). For example, a message indicating that the system switching may be performed may be displayed on a display (not illustrated) as the notification.

After that, the control unit 302 instructs the table management unit 303 to update the environment master table 305 by setting “ACT” as the operation flag for the server 10 capable of switching (step H14).

The control unit 302 confirms whether the update of the environment master table 305 by the table management unit 303 is completed (step H15). When the update of the environment master table 305 is not completed (see NO route in step H15), the control unit 302 repeatedly performs step H15 and waits until the update of the environment master table 305 is completed.

The table management unit 303 receives an instruction to update the environment master table 305 from the control unit 302 (step H16), and in accordance with the instruction, sets “ACT” as the operation flag for the server 10 capable of switching in the environment master table 305 (step H17).

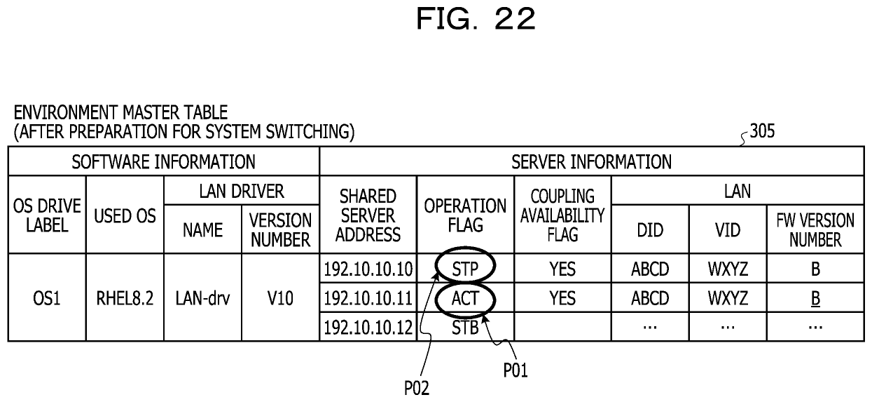

FIG. 22 is a diagram exemplifying the environment master table 305 after completion of preparation for system switching.

In the environment master table 305 exemplified in FIG. 22, “ACT” is set as the operation flag (see reference sign P01) for the server 10 with the shared server address of “192.10.10.11”, indicating that the server 10 is the new active server 10. “STP” is set as the operation flag (see reference sign P02) for the server 10 with the shared server address of “192.10.10.10”, indicating that the server 10 is stopped.

After that, the table management unit 303 notifies the control unit 302 that the update of the environment master table 305 is completed (step H18).

When completion of update of the environment master table 305 is notified from the table management unit 303 (see YES route in step H15), the control unit 302 notifies (responds to) the server control unit 201 of the active server 10 that the system switching may be performed (step H19).

When receiving an answer indicating that the system switching may or may not be performed (see YES route in step H2), the server control unit 201 of the active server 10 confirms whether the answer indicates that the system switching may be performed (step H20).

When the system switching may be performed (see YES route in step H20), the processing ends. For example, preparation for causing the server 10 capable of switching to function as the new active server 10 and taking over the task is completed.

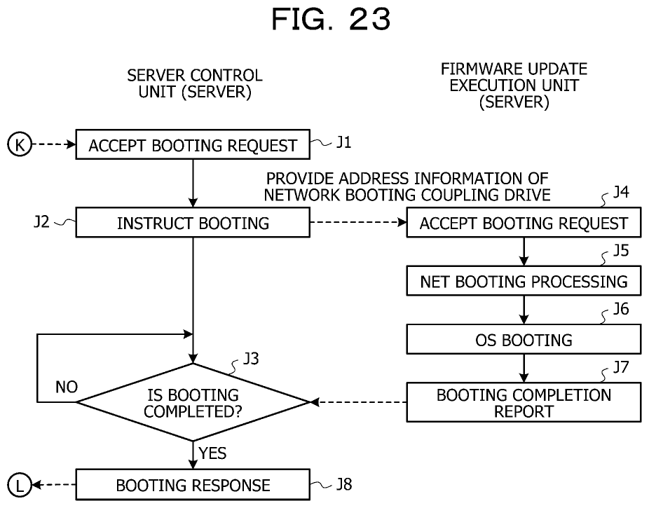

Next, processing of the standby server 10 as the switching destination at the time of switching (system switching) of the active server 10 will be explained with reference to a flowchart (steps J1 to J8) illustrated in FIG. 23.

The processing is started by the control unit 302 of the file server 30 giving a booting instruction to the server control unit 201 of the standby server 10 in step H11 of the flowchart illustrated in FIG. 20.

The server control unit 201 of the standby server 10 receives a booting request from the control unit 302 of the file server 30 (step J1).

The server control unit 201 gives the booting instruction to the firmware update execution unit 101 of the own server 10 (step J2). At this time, the server control unit 201 provides address information of a network booting coupling drive to the firmware update execution unit 101.

The server control unit 201 confirms whether the booting of the own server 10 is completed (step J3). When the booting is not completed (see NO route in step J3), the server control unit 201 repeatedly performs step J3 and waits until the booting is completed.

The firmware update execution unit 101 of the standby server 10 receives the booting instruction and the address information of the network booting coupling drive from the server control unit 201 of the server 10 (step J4). The firmware update execution unit 101 acquires a program and data to be used for activation processing from the network booting coupling drive, and performs network booting (step J5). After that, the firmware update execution unit 101 performs booting of the OS (step J6). The firmware update execution unit 101 notifies the server control unit 201 that the booting is completed (step J7).

When receiving a report from the firmware update execution unit 101 indicating that the booting is completed (see YES route in step J3), the server control unit 201 notifies (responds to) the control unit 302 of the file server 30 that the booting of the own server 10 is completed (step J8). After that, the processing returns to step H12 of the flowchart illustrated in FIG. 20.

### (C) Effects

As described above, according to the computer system 1 as an example of the embodiment, in the redundant system using network booting, the file server 30 performs management in the environment master table 305.

A combination of a device driver and the FW version number of the peripheral device 50 with which normal operation is guaranteed is managed in the environment master table 305.

In each server 10, the device scan processing unit 203 collects version number information of the FW of the peripheral device 50 mounted on the own server 10. In the file server 30, the control unit 302 compares the collected version number information of the FW with reference information (combination of a device driver and the FW version number of the peripheral device 50) which is registered in the environment master table 305 in advance and with which normal operation is guaranteed.

When the FW version number of the peripheral device 50 is not the same as the FW version number of the reference information as a result of the comparison, the control unit 302 of the file server 30 makes an FW update request to the server 10 so that the FW version number of the peripheral device 50 is the same as the FW version number of the reference information.

Accordingly, in the server 10, it is possible to suppress inconsistency between a device driver and the FW of the peripheral device 50, and it is possible to reduce the influence on the task due to an unintended failure.

The file server 30 manages the FW update files for the plurality of types of FW version numbers of the peripheral device 50, and transmits the FW update file corresponding to the version number of the device driver of the server 10 together with the FW update request.

Accordingly, in the server 10, the firmware update execution unit 101 may easily update the FW of the peripheral device 50 in which inconsistency is detected, and high convenience is achieved.

It is possible to detect, in advance, an environment in which a combination of the FW version number of the peripheral device 50 and a device driver incorporated in an OS logical drive has inconsistency (combination of version numbers incapable of operation). Accordingly, device FW may be updated to an appropriate version number (version number with consistency), and as a result, it is possible to suppress task suspension and task delay due to unintended occurrence of failure.

In the file server 30, the server scan processing unit 301 transmits, to each server 10, a server device scan request for requesting transmission of device information of the peripheral device 50 mounted on each server 10. In each server 10, the device scan processing unit 203 collects the device information of the peripheral devices 50 of the own server 10 in response to the server device scan request. The collected device information is provided as the device information table 231 from each server 10 to the file server 30. Accordingly, the file server 30 may easily collect the device information of the peripheral device 50 of each server 10.

In the environment master table 305, at least for the active server 10, information of a state in which normal operation is confirmed is registered. Accordingly, the information on the active server 10 in the environment master table 305 may be used as the reference information with which normal operation is guaranteed, and the reliability may be improved.

### (D) Others

The configuration and processing of the present embodiment may be selectively employed or omitted as desired, or may be combined as appropriate.

The disclosed technique is not limited to the embodiment described above, and may be carried out while being modified in various ways without departing from the gist of the present embodiment.

For example, although in the FW update file table 306 illustrated in FIG. 5, an update file name is registered for each FW version number and a corresponding FW update file is executed for each FW version number, this is not the only case. For example, a plurality of pieces of FW having different FW version numbers may be applied stepwise until a predetermined FW version number is reached. As described above, in the FW update file table 306, update files of a plurality of FW version numbers for reaching a predetermined FW version number may be managed.

For example, although the environment master table 305 illustrated in FIG. 4 indicates, as server information, information on a LAN interface as the peripheral device 50, this is not the only case. Information on other peripheral devices 50 may be managed in the environment master table 305.

Although the embodiment described above indicates an example in which the computer system 1 includes the file server 30, this is not the only case. A storage device may be provided instead of the file server 30, and the storage device may have the functions as the server scan processing unit 301, the control unit 302, and the table management unit 303 described above.

Although the information on the active server 10 in the environment master table 305 is used as the reference information with which normal operation is guaranteed, this is not the only case. For example, a system configuration (combination of a device driver and the FW version number of the peripheral device 50) with which normal operation is guaranteed may be defined in advance, and the defined information may be used as the reference information. For example, whether the FW version numbers are the same or not the same may be determined by comparing the value of the FW version number in the environment master table 305 with such reference information, and the present embodiment may be carried out while being modified in various ways.

Although the embodiment described above indicates an example in which the computer system 1 is the active/standby system, this is not the only case. For example, the computer system 1 may be a cluster system in which the plurality of servers 10 perform tasks in parallel without sharing an OS logical drive.

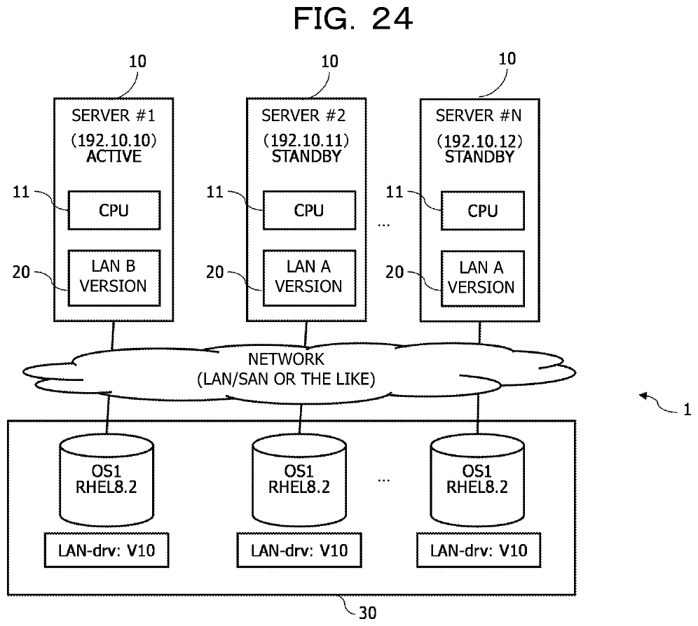

FIG. 24 is a diagram illustrating a modification example of the configuration of the computer system 1 as an example of the embodiment, and illustrates an example in which the computer system 1 is configured as the cluster system.

In the cluster system, a group composed of two or more servers 10 among the plurality of servers 10 is set. Among the two or more servers 10 composing the group, at least one server 10 is defined as a reference server 10.

The reference server 10 is the server 10 on which the peripheral device 50, to which a correct FW version number serving as a reference for performing FW version number comparison is applied, is mounted.

Even in a case where the computer system 1 is configured as the cluster system, each of the servers 10 and the file server 30 has the same configuration as that of the active/standby system described above.

In the cluster system, the server scan processing unit 301 of the file server 30 transmits a server device scan request to the plurality of servers 10 defined as a group.

In the cluster system, in the file server 30, the control unit 302 performs the following processing in a case where there is a difference in FW version number of the mounted peripheral device 50 of the same type (same model) among the servers 10 registered in the environment master table 305.

For example, the control unit 302 makes an FW update request for the peripheral device 50 to the servers 10 other than the reference server 10 among the cluster servers defined as a group with different FW version numbers so that the different version numbers will be the same as (consistent with) the FW version number of the device mounted on the reference server 10 among the cluster servers defined as a group.

At the time of making the FW update request, the control unit 302 selects and transmits an appropriate FW update file based on the contents of the FW update file table 306.

In a case where there is no difference in FW version number of the mounted peripheral device 50 of the same type (same model) among the servers 10 registered in the environment master table 305, there is no problem, and thus no particular processing is performed.

In the cluster system, the control unit 302 may remove the server 10 in which the FW update has abnormally ended from the cluster after making, to the system administrator, an alert notification indicating that the FW update may not be completed in the server 10 and that the server 10 may not be used as the system switching server. When the server 10 in which the FW update has abnormally ended is removed from the cluster (ends coupling), extra time may be provided until the end of coupling.

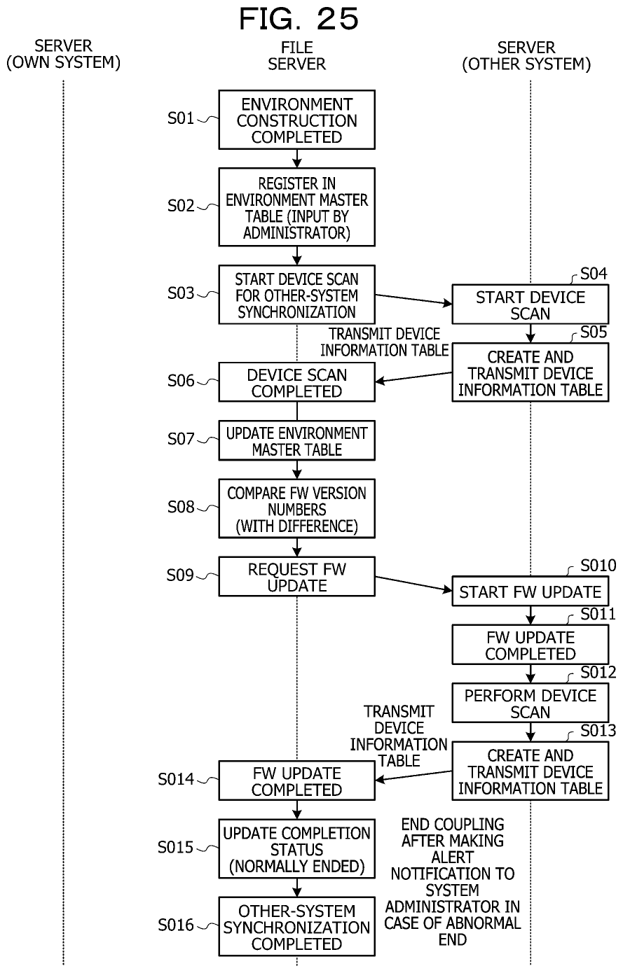

An overview of processing in the computer system 1 configured as the cluster system as the modification example of the embodiment will be explained with reference to a sequence diagram (steps S01 to S016) illustrated in FIG. 25.

In the following processing, when there are a plurality of other-system servers 10, the processing is performed on each of the plurality of other-system servers 10.

First, an environment is constructed in the file server 30 (step S01).

Next, in the file server 30, the system administrator inputs information to be registered in the environment master table 305 (step S02).

In the file server 30, the server scan processing unit 301 transmits a server device scan request to the servers 10 (other-system servers 10) defined as a group, and starts acquisition of device information of the peripheral devices 50 mounted on the other-system servers 10 (step S03).

The server scan processing unit 301 transmits, to the other-system server 10, a transmission request of the device information table 231 in which the result of the device scan is reflected.

In the other-system server 10, the device scan processing unit 203 performs collection of information (device information) on the peripheral device 50 mounted on the own server 10 in accordance with a device scan instruction issued from the server control unit 201 (step S04).

In the other-system server 10, the device table management unit 202 registers the device information of the own server 10 collected by the device scan processing unit 203 in the device information table 231. For example, the device table management unit 202 creates the device information table 231.

In the other-system server 10, the device scan processing unit 203 completes the collection of device information in the own server 10. The device scan processing unit 203 notifies the file server 30 of the completion of the device scan (step S05).

The server control unit 201 transmits the device information table 231 created by the device table management unit 202 to the file server 30.

In the file server 30, the control unit 302 receives the device information table 231 from the other-system server 10, and completes the device scan of the other-system server 10 (step S06).

In the file server 30, the table management unit 303 updates the environment master table 305 by using the received contents of the device information table 231 (step S07).

In the file server 30, the control unit 302 performs comparison for an item (FW version number) in the environment master table 305 (step S08).

When the FW version numbers are different between the peripheral devices 50 of the same type a result of the comparison, the control unit 302 issues an FW update request for the peripheral device 50 to the other-system server 10 (step S09). At this time, the control unit 302 transmits, to the other-system server 10, the FW update file 307 for achieving FW update in the standby other-system server 10.

When the FW version numbers are the same (have no difference), the control unit 302 determines that there is no deficiency in the consistency of the FW version numbers and does not issue the FW update request, and causes the processing to proceed to step S015.

In the other-system server 10 that has received the FW update request and the FW update file, FW update is performed by the server control unit 201 causing the firmware update execution unit 101 to execute the FW update file (steps S010 and S011).

In the other-system server 10, the server control unit 201 issues a device scan instruction to the device scan processing unit 203. The device scan processing unit 203 collects information (device information) of the peripheral device 50 mounted on the own server 10 in accordance with the device scan instruction (step S012).

In the other-system server 10, the server control unit 201 causes the device table management unit 202 to register the device information collected by the device scan processing unit 203 in the device information table 231. The device table management unit 202 registers the device information of the own server 10 collected by the device scan processing unit 203 in the device information table 231.

The server control unit 201 provides the device information table 231 to the file server 30 (step S013).

In the file server 30, the control unit 302 receives the notification of FW update completion and the device information table 231 transmitted from the other-system server 10, and processes the completion of the FW update of the other-system server 10 (step S014). For example, the control unit 302 causes the table management unit 303 to update the FW version number of the peripheral device 50 corresponding to the other-system server 10 in the environment master table 305 to a value after the FW update (step S015).

The control unit 302 causes the table management unit 303 to set “YES” as the coupling availability flag of the standby server 10 in the environment master table 305. Accordingly, the other-system server 10 is thereafter treated as being capable of coupling. Accordingly, synchronization of the FW in each other-system server 10 is completed (step S016).

As described above, the computer system 1 may also be applied as the cluster system, and the same effect as that of the active/standby system may be obtained.

In the cluster system, when the FW update abnormal end response (other than normal end) is received from the server 10 to be updated, the request for coupling to the OS logical drive is rejected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer system comprising a management apparatus and a plurality of information processing apparatuses each including a peripheral device,
wherein the management apparatus including
a memory, and
a processor coupled to the memory and configured to:
compare version number information of firmware of the peripheral device mounted on each of the plurality of information processing apparatuses with preset reference information; and
in a case where the version number information of firmware is not consistent with the reference information, update firmware of the information processing apparatus so that a version number of firmware of the information processing apparatus becomes consistent with a version number of the reference information.

2. The computer system according to claim 1,
wherein the reference information includes a firmware version number of the peripheral device mounted on an information processing apparatus that is confirmed to operate normally among the plurality of information processing apparatuses.

3. The computer system according to claim 1,
wherein the processor is further configured to:
request the information processing apparatus to collect version number information of firmware of the peripheral device that is mounted, and
in the compare, the version number information of firmware collected by the information processing apparatus is compared with the reference information.

4. A control method for a computer system comprising a management apparatus and a plurality of information processing apparatuses each including a peripheral device, the control method performed by the management apparatus including steps of:
comparing version number information of firmware of the peripheral device mounted on each of the plurality of information processing apparatuses with preset reference information; and
updating, in a case where the version number information of firmware is not consistent with the reference information, firmware of the information processing apparatus so that a version number of firmware of the information processing apparatus becomes consistent with a version number of the reference information.

5. The control method according to claim 4,
wherein the reference information includes a firmware version number of the peripheral device mounted on an information processing apparatus that is confirmed to operate normally among the plurality of information processing apparatuses.

6. The control method according to claim 4,
wherein the control method further including:
requesting the information processing apparatus to collect version number information of firmware of the peripheral device that is mounted, and
in the comparing, the version number information of firmware collected by the information processing apparatus is compared with the reference information.
